(19) United States
(12) Patent Application Publication
(10) Pub. No.: US 2021/0380415 A1
(43) Pub. Date: Dec. 9, 2021

(54) GRAPHITIC MATERIALS

(71) Applicant: COMMONWEALTH SCIENTIFIC AND INDUSTRIAL RESEARCH ORGANISATION, Acton, Australian Capital Territory (AU)

(72) Inventors: Thomas KOHL, Clayton, Victoria (AU); John TSANAKTSIDIS, Clayton, Victoria (AU)

(21) Appl. No.: 17/282,558

(22) PCT Filed: Oct. 11, 2019
(86) PCT No.: PCT/AU2019/051109

§ 371 Date: Apr. 2, 2021

(30) Foreign Application Priority Data
Oct. 12, 2018 (AU) 2018903868

(51) Int. Cl. C01B 32/205; B01J 6/00

(52) U.S. Cl. CPC C01B 32/205; B01J 6/008; C01P 2006/40; C01P 2004/24; C01P 2004/64; C01P 2004/03

(57) ABSTRACT

The present disclosure relates to graphitic materials and to methods for preparing graphitic materials including processes for preparing graphitic materials comprising a predetermined heteroatom content by heating a conducting polymer.

### FIELD

The present disclosure relates to graphitic materials and to methods for preparing graphitic materials. The present disclosure also relates to processes for preparing graphitic materials comprising a predetermined heteroatom content by heating a conducting polymer.

### BACKGROUND

Graphene and graphitic materials are of significant commercial value although the production methods for preparing such materials is still considerably limited. Despite the many successes and promises of graphene and graphitic materials, it is yet to be widely used in many commercial applications. There are significant difficulties in producing graphene and graphitic materials, and particularly with the commercial scalability of the processes being used.

Although there are currently many methods available for producing graphene, they each have their problems. For example, there are methods that produce the high-quality graphene but only in small quantities, and those that can produce a larger amount of graphene are poor in quality for most commercial applications. Scalability, variability of materials, impurities and time consuming and costly processing techniques are among some of the issues currently faced when producing graphene. However, the main problem to overcome is up-scaling graphene production. The challenge lies in maintaining the quality when producing large quantities of graphene. If defects are present in the graphene monolayer carbon network, it can dramatically affect properties of the graphene such as the electrical conductivity, transparency, impermeability, or thermal conductivity. Currently there are two different types of methods for producing graphene—the bottom up and top down method. The bottom up method to produce graphene uses chemical assembly of carbon atoms in order to create the monolayer structure associated with graphene. The most common being a process known as chemical vapour deposition (CVD). CVD permits production of a monolayer of graphene directly onto a copper or nickel substrate. The problem associated with this technique is that if you want to place graphene on any arbitrary substrate it needs to be transferred from copper on which the material is prepared, which induces defects on the monolayers, such as holes and cracks. The top down method refers to the process of breaking the stacked layers of graphite to produce graphene monolayers. This is currently the most widely used method to produce higher quality graphene. However, this top down method is costly so makes it unsuitable for large scale production.

Producing graphene or graphitic materials in various structures and phases can enhance versatility in the material's application. One way to enhance graphene or graphitic materials is to incorporate active sites on the graphitic structure by substituting a carbon atom for another element, otherwise known as doping or grafting elements, i.e. nitrogen, boron, phosphorus, sulphur, etc. However, the lack of an appropriate synthesis route for providing both high quality and quantity of doped-graphene/graphitic material hinders its commercial use.

There are currently demands for the production of graphene and graphitic materials that have commercially suitable properties, such as one or more of high conductivity, functionality, dispersibility, and/or capability of forming films and coatings for specialty applications.

Consequently, there is a need for developing alternative commercial processes for producing graphene and various graphitic materials that is controllable, cost effective and scalable.

### SUMMARY

The present inventors have identified a process for controlled production of graphene and various graphitic materials. The process can comprise heating of a conducting polymer to form a graphitic material. In one example, the process can comprise or consist of heating a conducting polymer to a predetermined temperature to initiate formation of the graphitic material. One or more advantages of the present process according to at least some embodiments or examples as described herein is that the process is scalable and can provide a graphitic material having commercially suitable functionality and dispersibility starting from a conducting polymer. The conducting polymer can be selected to be soluble in an organic solvent for which the end product graphitic material can be appropriate for use in various formulations, films, coatings, composites and materials. The present inventors have surprisingly found that heating a conducting polymer, such as a polyaniline sulfonate salt, to a predetermined temperature via a heating process can produce a functional and dispersible graphitic material. The graphitic material produced may also be used for specialty applications, such as conductive coatings, making it particularly suitable for various applications. According to at least some of the embodiments or examples as described herein, the process is controllable to provide production of commercially versatile graphitic materials.

In one aspect there is provided a method of preparing a graphitic material from a conducting polymer, wherein the method comprises or consists of a step of heating the conducting polymer to a predetermined temperature to produce the graphitic material. In another aspect there is provided a method of preparing a graphitic material from a solid conducting polymer material, the method comprising a heating step, and wherein the heating step consists of heating the solid conducting polymer material to a predetermined temperature to provide a solid phase conversion of the solid conducting polymer material into the graphitic material.

In an embodiment, the conducting polymer is a polyaniline base or polyaniline salt. In one example, the polyaniline salt is a polyaniline sulfonate salt. In another example, the polyaniline sulfonate salt is a polyaniline dinonylnapthalenesulfonate salt.

In another embodiment, the method comprises or consists of the following steps: (i) heating the conducting polymer to a predetermined temperature to initiate formation of a graphitic material; and (ii) optionally cooling the graphitic material. The predetermined temperature for step (i) may be between about 200° C. to about 2200° C.

In another embodiment, the heating of the conducting polymer may further comprise or consist of (i)(a) pre-heating the conducting polymer to a predetermined temperature to produce a stabilised conducting polymer prior to step (i)(b) of heating the conducting polymer to a predetermined temperature to initiate formation of a graphitic material. The predetermined temperature of step (i)(a) may be between about 200° C. to about 600° C. The predetermined temperature of step (i) may be between about 600° C. to about 2200° C. The predetermined temperature for step (i)(b) may be provided according to any embodiments or examples as described herein for step (i).

In another embodiment, the conducting polymer is maintained at the predetermined temperature of step (i)(a) for about 30 to about 180 minutes. In another embodiment, the conducting polymer is maintained at the predetermined temperature for step (i) or step (i)(b) for about 30 to about 180 minutes. The conducting polymer may be heated to the predetermined temperature for step (i) or step (i)(b) at a rate of about 2° C. to about 15° C./minute. The conducting polymer may be pre-heated to the predetermined temperature for step (i)(a) at a rate of about 2° C. to about 15° C./minute.

In another embodiment, the graphitic material formed in step (i) or step (i)(b) may cooled in step (ii) to ambient temperature at a rate of about 2° C. to about 100° C./minute.

In another embodiment, the method or a heating step thereof may performed in a controlled environment. The controlled environment may comprise air or inert gas. The controlled environment may comprise atmospheric pressure or vacuum.

The graphitic material may have a conductivity of between about 0.5 S/cm to about 1000 S/cm.

In another embodiment, the graphitic material has a content of heteroatom after step (i), wherein the heteroatom is selected from the group consisting of nitrogen, oxygen, sulphur, and combinations thereof. The content of nitrogen may be in an amount of about 0.2% to about 20%. In an embodiment, the heteroatom content may be controlled by heating the graphitic material to a temperature of between about 350° C. to about 2200° C.

In another embodiment, the graphitic material has a content of graphitic nitrogen, pyridinic nitrogen, pyrrolic nitrogen, or a combination thereof.

In an embodiment, the method further comprises heating the conducting polymer on a substrate to form a film or coating of graphitic material on the substrate. The conducting polymer may be dissolved in an organic solvent for coating the substrate prior to heating to form the film or coating of graphitic material on the substrate.

The substrate may be selected from metal, plastic, ceramic, or composite.

In another embodiment, the graphitic material is obtained from the process in the form of a coating or film. The coating or film can have a substantially uniform thickness.

In yet another embodiment, the graphitic material is obtained from the process in the form of a graphitic powder.

In another aspect, there is provided a graphitic material prepared by a method as defined above or any embodiments or examples thereof as described herein.

In another aspect, there is provided a graphitic powder prepared by a method defined above or any embodiments or examples thereof as described herein.

In another aspect, there is provided a graphitic coating prepared by a method defined above or any embodiments or examples thereof as described herein.

In another aspect, there is provided a graphitic film prepared by a method defined above or any embodiments or examples thereof as described herein.

In another aspect there is provided a coating on a substrate prepared from the graphitic material according to the method defined above or any embodiments or examples thereof as described herein.

In another aspect, there is provided a filler comprising the graphitic powder prepared according to the method defined above or any embodiments or examples thereof as described herein.

In another aspect, there is provided a composite comprising the graphitic powder prepared according to the method defined above or any embodiments or examples thereof as described herein.

In another aspect, there is provided a graphitic powder comprising a graphitic material, wherein the graphitic material has a content of heteroatom, and wherein the graphitic powder is prepared from a conducting polymer.

In another aspect, there is provided a graphitic film or a graphitic coating on a substrate, wherein the film or coating comprises a graphitic material having a content of heteroatom, and wherein the graphitic material is prepared from a conducting polymer.

It will be appreciated that further aspects and embodiments are described herein, which may include one or more of the features as described above.

The features, functions, and advantages that have been discussed can be achieved independently in various embodiments or may be combined with yet other embodiments, and further details of which can be seen with reference to the following description and drawings.

### BRIEF DESCRIPTION OF THE DRAWINGS

Some embodiments of the present disclosure are described and illustrated herein, by way of example only, with reference to the accompanying Figures in which:

FIG. 1 is a graph showing PANI-DNNSA thermogravimetric analysis (TGA) 800° C. ramping at 5° C./min in air.

FIG. 2 is a graph showing PANI-DNNSA thermogravimetric analysis (TGA) 800° C. ramping at 5° C./min under N_{2 (g)}.

FIG. 3 is a graph showing PANI-DNNSA TGA-MS 800° C. ramping at 5° C./min under N_{2 (g)}. Evolution of SO (m/z 48), SO₂ (m/z 64) and SO₃ (m/z 80) detected from 200-600° C.

FIG. 4 is a graph showing experimentally derived actual and expected mass loss data for different PANI species related to the number of carbon atoms (i.e. bulk) of the sulphonate salt.

FIG. 5 is a graph showing PANI-DNNSA TGA-MS 800° C. ramping at 5° C./min under N_{2 (g)}. Evolution of the aniline anion (m/z 92) as depolymerisation occurs during the second stage of decomposition.

FIG. 6 is a graph showing PANI-base TGA-MS 800° C. ramping at 5° C./min under N_{2 (g)}. Evolution of the aniline anion (m/z 92) as depolymerisation occurs during decomposition.

FIG. 7 is a graph showing pre-carbonisation XPS data summarised from the high resolution nitrogen spectrum of PANI-base and PANI-salt precursors.

FIG. 8 is a graph showing post-carbonisation XPS data summarised from the high resolution nitrogen spectrum of PANI-base and PANI-salt graphitic materials.

FIG. 9 is a graph showing the effect of pyrolysis temperature on the relative fraction of nitrogen (%) from the total nitrogen contained in the graphitic material.

FIG. 10 is a graph showing the effect of soak time on the relative fraction of nitrogen (%) from the total nitrogen contained in the graphitic material.

FIG. 11 is a graph showing the effect of ramp rate on the relative fraction of nitrogen (%) from the total nitrogen contained in the graphitic material.

FIG. 12 is a graph showing the variation in 0 and N atomic (%) with pyrolysis temperature from XPS data.

FIGS. 13A-L are scanning electron microscopy images showing morphological differences between PANI-base and PANI-salt precursors and their resulting graphitic materials, compared to synthetic graphite and graphene nanoplatelets.

FIG. 14 is a graph showing an overlay of Raman spectra for graphitic material derived from PANI-DNNSA.

FIG. 15 is a graph showing the relationship between pyrolysis temperature and graphitic film conductivity.

### DETAILED DESCRIPTION

The present disclosure describes the following various non-limiting examples, which relate to investigations undertaken to identify alternative methods for preparing graphene and various graphitic materials. The present inventors have identified a process for controlled production of graphene and various graphitic materials comprising heating a conducting polymer. The process comprises heating a conducting polymer to a predetermined temperature to initiate formation of the graphitic material. According to at least some embodiments or examples as described herein, the present process can provide a graphitic material having good functionality and dispersibility, which can be cost-effectively prepared from a conducting polymer. The conducting polymer can be selected to be soluble in an organic solvent for which the end product graphitic material can be advantageously appropriate for use in various formulations, films, coatings, composites and materials. The present inventors have surprisingly found that heating a conducting polymer to a predetermined temperature can produce a functional and dispersible graphitic material suitable for specialty applications, such as conductive coatings. The graphitic nature of the end product graphitic material prepared by at least some of the embodiments or examples as described herein is controllable and can allow for versatility in its application.

### General Terms

Throughout this disclosure, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the steps, features, compositions and compounds referred to or indicated in this specification, individually or collectively, and any and all combinations or any two or more of said steps or features.

Each example of the present disclosure described herein is to be applied mutatis mutandis to each and every other example unless specifically stated otherwise. The present disclosure is not to be limited in scope by the specific examples described herein, which are intended for the purpose of exemplification only. Functionally-equivalent products, compositions and methods are clearly within the scope of the disclosure as described herein.

The term “and/or”, e.g., “X and/or Y” shall be understood to mean either “X and Y” or “X or Y” and shall be taken to provide explicit support for both meanings or for either meaning.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The term “consists of”, or variations such as “consisting of”, refers to the inclusion of any stated element, integer or step, or group of elements, integers or steps, that are recited in context with this term, and excludes any other element, integer or step, or group of elements, integers or steps, that are not recited in context with this term.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

Reference herein to “example,” “one example,” “another example,” or similar language means that one or more feature, structure, element, component or characteristic described in connection with the example is included in at least one embodiment or implementation. Thus, the phrases “in one example,” “as one example,” and similar language throughout the present disclosure may, but do not necessarily, refer to the same example. Further, the subject matter characterizing any one example may, but does not necessarily, include the subject matter characterizing any other example.

It will be clearly understood that, although a number of prior art publications are referred to herein, this reference does not constitute an admission that any of these documents forms part of the common general knowledge in the art, in Australia or in any other country.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

### Production of Graphitic Materials

The present disclosure provides a method of preparing a graphitic material by heating a conducting polymer. The process may comprise or consist of a heating step. The present disclosure also provides a method of preparing a graphitic material from a solid conducting polymer material. The process may comprise or consist of a heating step, wherein the heating step consists of heating the solid conducting polymer material to a predetermined temperature to provide a solid phase conversion of the solid conducting polymer material into the graphitic material. The solid conducting material may be formed by removal of organic solvent present in a liquid conducting polymer formulation. In some embodiments or examples, the solid conducting material may be formed by heating the conducting polymer to a temperature of about 100° C. to 150° C. for about 30 minutes to about 120 minutes, most preferably 150° C. for 30 minutes. The process can enable the production of a graphitic material that is more readily processable and allows scalability for industrial and commercial applications.

It will be appreciated that the production of graphitic materials of the present disclosure contrasts with the production of doped graphene such as nitrogen-doped graphene (N-graphene) or graphene doped with a heteroatom (graphitic material). For example, in situ approaches characterized by simultaneous graphene synthesis and N-doping include chemical vapour deposition (CVD), ball milling, and solvothermal synthesis. CVD involves growth of N-graphene on a preheated structure (typically nickel or copper) in the carbon and nitrogen-containing environment. Although CVD is a common method for in situ N-graphene synthesis, it typically suffers from metal interference. Post-treatment methods include wet chemical methods, thermal annealing of graphene oxides (GO) with heteroatom precursors and plasma-based treatments. Several drawbacks arise from these methods, including degradation of the nanostructure properties due to the transition metals used, the requirement of expensive and/or hazardous catalysts, vacuum systems and very high temperatures, and lengthy/complex batch procedures. One method used for N-graphene production is GO in the presence of N-precursors. Whilst this is an attractive approach to produce N-graphene at a low-cost in larger scale, a major issue is that the chemical reduction of GO requires the use of toxic reducing agents and the end product graphitic material exhibits relatively poor electrical conductivity due to the contaminants, saturated sp³ bonds and bonded oxygen groups. Current production methods to obtain graphene and graphitic materials results in large variations in properties arising from processes used. For example, the production of graphitic materials has several problems including a) uncontrolled N bonding type and distribution and b) N doping at non-specific positions and untuned doping content.

At least according to some embodiments or examples as described herein, the present processes can provide a scalable, cost effective and controllable production of high quality graphitic material in a reproducible manner, using a heating process starting from a conducting polymer. It will be appreciated that the present process does not require any post formation doping of the graphitic material, for example to introduce heteroatom content to provide graphitic nitrogen into the graphitic material. In other words the conducting polymer used in the process already contains all aromatic and heteroatom content required to form the graphitic material.

### Heating Process

In one embodiment or example, there is provided a method of preparing a graphitic material comprising or consisting of the step of: (i) heating a conducting polymer to a predetermined temperature to form the graphitic material. The heating may be conducted under the presence of an inert gas, such as a flowing nitrogen atmosphere.

In another embodiment or example, there is provided a method of preparing a graphitic material comprising or consisting of the steps of: (i) heating a conducting polymer to a predetermined temperature to initiate formation of a graphitic material; and (ii) optionally cooling the graphitic material.

In another embodiment or example, there is provided a method of preparing a graphitic material comprising or consisting of the steps of: (i) heating the solid conducting polymer material to a temperature above about 550° C. to initiate formation of a graphitic material; and (ii) cooling the graphitic material. The cooling step may provide a controlled cooling of the graphitic material, for example by a forced or convection cooling. The cooling step may comprise removal of the heating and allowing the graphitic material to cool by exposure to a lower temperature environment. The cooling step may also be provided according to any one of the embodiments as described below in relation to cooling.

The heating of the conducting polymer provides a solid phase conversion of the conducting polymer to the graphitic material, for example the conducting polymer is converted to the graphitic material by heating without introducing any vapour phase process. It will be appreciated that the conducting polymer is not formed in the process, for example the process does not include any in-situ polymerisation of the conducting polymer. The present process involves use of a previously formed conducting polymer. The process can enable the heating of a higher purity conducting polymer to directly form a high purity graphitic material with a controlled heteroatom content. The process may further comprise or consist of a prior step of applying or coating a previously formed conducting polymer onto a scaffold and then heating the scaffold to form the graphitic material. It will be appreciated that the scaffold can tolerate the temperatures of the heating step. The previously formed conducting polymer may be a bulk powder or a coating. It will be appreciated that any solvent present in the powder or coating can be removed before heating or conversion to the graphitic material.

In a further embodiment or example, the method of preparing the graphitic material may further comprise a step of (i)(a) pre-heating the conducting polymer to a predetermined temperature to produce a stabilised conducting polymer, and (i)(b) heating the stabilised conducting polymer to a predetermined temperature to initiate formation of a graphitic material.

For example, the method of preparing a graphitic material may comprise or consist of the steps of: (i)(a) optionally pre-heating the conducting polymer to a predetermined temperature to produce a stabilised conducting polymer; (i)(b) heating the conducting polymer to a predetermined temperature to initiate formation of a graphitic material; and (ii) optionally cooling the graphitic material.

For step (i) the predetermined temperature may be between about 200° C. to about 2200° C. The predetermined temperature for step (i) may be in a range from between about 300° C. and 2000° C., about 400° C. and 1800° C., about 500° C. and 1600° C., or about 600° C. and 1000° C. For example, the predetermined temperature for step (i) may be in a range from between about 800° C. and 1200° C. The predetermined temperature for step (i) may be at least 200° C., at least 300° C., at least 400° C., at least 500° C., at least 600° C., at least 700° C., at least 800° C., at least 900° C., at least 1000° C., at least 1500° C., or at least 1800° C. The predetermined temperature for step (i) may be less than about 2200° C., less than about 2000° C., less than about 1800° C., less than about 1500° C., less than about 1000° C., less than about 900° C., less than about 800° C., or less than about 700° C. The predetermined temperature for step (i) may be provided in a range between any two of these previously described upper and/or lower values. The predetermined temperature may allow for a more controlled production of the graphitic material. For example, the predetermined temperature to form the graphitic material described herein from the conducting polymer is less than 2200° C. In an example, the predetermined temperature to form the graphitic material described herein from the conducting polymer is between 600° C. and 1200° C. For example, the predetermined temperature to form the graphitic material described herein from the conducting polymer is between 800° C. and 1200° C. It will be appreciated that the predetermined temperature for heating is provided below any pyrolytic temperature of the conducting polymer such that the conversion of the solid conducting polymer into the graphitic material occurs in the solid phase (e.g. a solid conducting polymer is directly converted by heating into a solid graphitic material).

For step (i)(a) the predetermined temperature may be in a range between about 200° C. and about 600° C. The predetermined temperature for step (i)(a) may be in a range from between about 250° C. and 550° C., about 300° C. and 500° C., or about 350° C. and 450° C. The predetermined temperature for step (i)(a) may be at least 200° C., at least 300° C., at least 400° C., or at least 500° C. The predetermined temperature for step (i)(a) may be less than about 600° C., less than about 550° C., less than about 500° C., less than about 450° C., less than about 400° C., or less than about 350° C. The predetermined temperature for step (i)(a) may be provided in a range between any two of these previously described upper and/or lower values.

For step (i)(b) the predetermined temperature may be in a range between about 600° C. to about 2200° C. The predetermined temperature for step (i)(b) may be in a range from between about 650° C. and 2000° C., about 700° C. and 1800° C., about 750° C. and 1600° C., or about 800° C. and 1000° C. The predetermined temperature for step (i)(b) may be in a range from between about 650° C. and 900° C. The predetermined temperature for step (i)(b) may be at least 600° C., at least 700° C., at least 800° C., at least 900° C., at least 1000° C., at least 1500° C., at least 1800° C., or at least 2000° C. The predetermined temperature for step (i)(b) may be less than about 2200° C., less than about 2000° C., less than about 1800° C., less than about 1500° C., less than about 1000° C., less than about 900° C., less than about 800° C., or less than about 700° C. In an example, the predetermined temperature to form the graphitic material described herein from the conducting polymer is between 600° C. and 1200° C. For example, the predetermined temperature to form the graphitic material described herein from the conducting polymer is between 800° C. and 1200° C. The predetermined temperature for step (i)(b) may be provided in a range between any two of these previously described upper and/or lower values.

At least according to some embodiments or examples as described herein, the conducting polymer may be maintained at the predetermined temperature in step (i)(a) for about 30 to about 180 minutes. The conducting polymer may be maintained at the predetermined temperature in step (i)(a) for about 35 and 170 minutes, about 40 and 160 minutes, about 42 and 140 minutes, about 45 and 120 minutes, about 48 and 100 minutes, about 50 and 80 minutes, or about 55 and 70 minutes. The conducting polymer may be maintained at the initial predetermined temperature for step (i)(a) for at least 60 minutes, at least 70 minutes, at least 80 minutes, at least 90 minutes, at least 100 minutes, at least 110 minutes, at least 120 minutes, at least 130 minutes, at least 140 minutes, at least 150 minutes, at least 160 minutes, or at least 170 minutes. The conducting polymer may be maintained at the predetermined initial temperature for step (i)(a) for less than 180 minutes, less than 170 minutes, less than 160 minutes, less than 150 minutes, less than 140 minutes, less than 130 minutes, less than 120 minutes, less than 110 minutes, less than 100 minutes, less than 90 minutes, or less than 70 minutes. The predetermined temperature for step (i)(a) may be provided in a range between any two of these previously described upper and/or lower values.

In some embodiments or examples as described herein, the conducting polymer may be maintained at the predetermined temperature in step (i)(a) for about 0 to about 240 minutes. The conducting polymer may be maintained at the predetermined temperature in step (i)(a) for about 5 and 220 minutes, about 10 and 200 minutes, about 15 and 180 minutes, about 20 and 150 minutes, about 25 and 100 minutes, or about 30 and 60 minutes. The conducting polymer may be maintained at the initial predetermined temperature for step (i)(a) for at least 1 minute, at least 5 minutes, at least 10 minutes, at least 15 minutes, at least 20 minutes, at least 25 minutes, at least 30 minutes, at least 35 minutes, at least 40 minutes, at least 45 minutes, at least 50 minutes, or at least 55 minutes. The conducting polymer may be maintained at the predetermined initial temperature for step (i)(a) for less than 200 minutes, less than 180 minutes, less than 160 minutes, less than 140 minutes, less than 120 minutes, less than 110 minutes, less than 100 minutes, less than 90 minutes, less than 80 minutes, less than 70 minutes, or less than 60 minutes. The predetermined temperature for step (i)(a) may be provided in a range between any two of these previously described upper and/or lower values.

In some embodiments or examples, the conducting polymer may be maintained at the predetermined temperature for step (i) or step (i)(b) for about 30 to about 180 minutes. The conducting polymer may be maintained at the predetermined temperature for step (i) or step (i)(b) for about 35 and 180 minutes, about 40 and 160 minutes, about 42 and 140 minutes, about 45 and 120 minutes, about 48 and 100 minutes, about 50 and 80 minutes, or about 55 and 70 minutes. The conducting polymer may be maintained at the predetermined temperature for step (i) or step (i)(b) for at least 60 minutes, at least 70 minutes, at least 80 minutes, at least 90 minutes, at least 100 minutes, at least 110 minutes, at least 120 minutes, at least 130 minutes, at least 140 minutes, at least 150 minutes, at least 160 minutes, or at least 170 minutes. The conducting polymer may be maintained at the predetermined temperature for step (i) or step (i)(b) for less than 180 minutes, less than 170 minutes, less than 160 minutes, less than 150 minutes, less than 140 minutes, less than 130 minutes, less than 120 minutes, less than 110 minutes, less than 100 minutes, less than 90 minutes, or less than 70 minutes. The predetermined temperature for step (i) or step (i)(b) may be provided in a range between any two of these previously described upper and/or lower values.

In some embodiments or examples, the conducting polymer may be maintained at the predetermined temperature for step (i) or step (i)(b) for about 0 to about 240 minutes. The conducting polymer may be maintained at the predetermined temperature for step (i) or step (i)(b) for about 5 and 220 minutes, about 10 and 200 minutes, about 15 and 180 minutes, about 20 and 150 minutes, about 25 and 100 minutes, or about 30 and 60 minutes. The conducting polymer may be maintained at the predetermined temperature for step (i) or step (i)(b) for at least 1 minute, at least 5 minutes, at least 10 minutes, at least 15 minutes, at least 20 minutes, at least 25 minutes, at least 30 minutes, at least 35 minutes, at least 40 minutes, at least 45 minutes, at least 50 minutes, or at least 55 minutes. The conducting polymer may be maintained at the predetermined temperature for step (i) or step (i)(b) for less than 200 minutes, less than 180 minutes, less than 160 minutes, less than 140 minutes, less than 120 minutes, less than 110 minutes, less than 100 minutes, less than 90 minutes, less than 80 minutes, less than 70 minutes, or less than 60 minutes. The predetermined temperature for step (i) or step (i)(b) may be provided in a range between any two of these previously described upper and/or lower values.

At least according to some embodiments or examples as described herein, the conducting polymer may be pre-heated to the predetermined temperature for step (i)(a) at a rate of about 2° C./minute to about 15° C./minute, about 4° C./minute to about 12° C./minute, or about 6° C./minute to about 10° C./minute. The conducting polymer may be pre-heated to the predetermined temperature for step (i)(a) at a rate of less than about 15° C./minute, less than about 12° C./minute, less than about 10° C./minute, less than about 8° C./minute, less than 6° C./minute, or less than 4° C./minute. The conducting polymer may be pre-heated to the predetermined temperature for step (i)(a) at a rate of at least about 4° C./minutes, at least about 6° C./minutes, at least about 8° C./minutes, at least about 10° C./minutes, or at least about 12° C./minutes. The conducting polymer may be pre-heated to the predetermined temperature step (i)(a) at a rate that may be provided in a range between any two of these previously described upper and/or lower values.

In some embodiments or examples as described herein, the conducting polymer may be pre-heated to the predetermined temperature for step (i)(a) at a rate of about 1° C./minute to about 50° C./minute, about 10° C./minute to about 40° C./minute, or about 15° C./minute to about 30° C./minute. The conducting polymer may be pre-heated to the predetermined temperature for step (i)(a) at a rate of less than about 40° C./minute, less than about 35° C./minute, less than about 30° C./minute, less than about 25° C./minute, less than 20° C./minute, or less than 15° C./minute. The conducting polymer may be pre-heated to the predetermined temperature for step (i)(a) at a rate of at least about 1° C./minutes, at least about 5° C./minute, at least about 10° C./minute, at least about 15° C./minute, or at least about 20° C./minute. The conducting polymer may be pre-heated to the predetermined temperature step (i)(a) at a rate that may be provided in a range between any two of these previously described upper and/or lower values.

In another embodiment or example, the conducting polymer may be heated to the predetermined temperature for step (i) or step (i)(b) at a rate of about 2° C. to about 15° C./minute, about 4° C./minute to about 12° C./minute, or about 6° C./minute to about 10° C./minute. The conducting polymer may be heated to the predetermined temperature for step (i) or step (i)(b) at a rate of less than about 15° C./minute, less than about 12° C./minute, less than about 10° C./minute, less than about 8° C./minute, less than 6° C./minute, or less than 4° C./minute. The conducting polymer can be heated to the predetermined temperature for step (i) or step (i)(b) at a rate of at least about 4° C./minutes, at least about 6° C./minutes, at least about 8° C./minutes, at least about 10° C./minutes, or at least about 12° C./minutes. The conducting polymer may be heated to the predetermined temperature step (i) or step (i)(b) at a rate that may be provided in a range between any two of these previously described upper and/or lower values.

In yet another embodiment or example, the conducting polymer may be heated to the predetermined temperature for step (i) or step (i)(b) at a rate of about 1° C./minute to about 50° C./minute, about 10° C./minute to about 40° C./minute, or about 15° C./minute to about 30° C./minute. The conducting polymer may be heated to the predetermined temperature for step (i) or step (i)(b) at a rate of less than about 40° C./minute, less than about 35° C./minute, less than about 30° C./minute, less than about 25° C./minute, less than 20° C./minute, or less than 15° C./minute. The conducting polymer can be heated to the predetermined temperature for step (i) or step (i)(b) at a rate of at least about 1° C./minute, at least about 5° C./minute, at least about 10° C./minute, at least about 15° C./minute, or at least about 20° C./minute. The conducting polymer may be heated to the predetermined temperature step (i) or step (i)(b) at a rate that may be provided in a range between any two of these previously described upper and/or lower values.

In another embodiment or example, the graphitic material formed in step (i) or step (i)(b) can be cooled in step (ii) to ambient temperature at a rate of about 1° C./minute to about 100° C./minute, about 2° C./minute to about 100° C./minute, about 50° C./minute to about 80° C./minute, about 25° C. to about 50° C./minute, about 25° C. to about 40° C./minute, about 15° C. to about 25° C./minute, or about 5° C. to about 15° C./minute. The graphitic material formed in step (i) or step (i)(b) can be cooled in step (ii) to ambient temperature at a rate of less than about 100° C./minute, less than about 80° C./minute, less than about 60° C./minute, less than about 40° C./minute, less than about 20° C./minute, less than about 10° C./minute, or less than about 5° C./minute. The graphitic material formed in step (i) or step (i)(b) can be cooled in step (ii) to ambient temperature at a rate of at least about 1° C./minute, at least about 5° C./minute, at least about 10° C./minute, at least about 20° C./minute, at least about 40° C./minute, at least about 60° C./minute, or at least about 80° C./minute. The graphitic material formed in step (i) or step (i)(b) can be cooled in step (ii) to ambient temperature at a rate at a rate that may be provided in a range between any two of these previously described upper and/or lower values. The rate of cooling may influence the nanostructure of the graphitic material. In another embodiment or example, the graphitic material formed in step (i) or step (i)(b) can be cooled in step (ii) to ambient temperature at a rate of about 10° C./minute to about 100° C./minute. In yet another embodiment or example, cooling the graphitic material formed in step (i) or step (i)(b) at a controlled rate may be, for example, cooling the graphitic material formed to ambient temperature at a rate of 1° C./minute to 100° C./minute, 50° C./minute to 100° C./minute, 25° C./minute to 50° C./minute, 25° C./minute to 40° C./minute, 15° C./minute to 25° C./minute, or 5° C./minute to 15° C./minute. In one example, cooling the graphitic material formed in step (ii) to ambient temperature may be at a rate of less than 5° C./minute. In another example, cooling the graphitic material formed in step (ii) to ambient temperature may be at a rate of up to 18° C./minute or at a rate of up to 25° C./minute. The graphitic material formed in step (i) or step (i)(b) can be cooled in step (ii) to ambient temperature at a rate at a rate that may be provided in a range between any two of these previously described upper and/or lower values.

### Conducting Polymer

Conducting polymers are polymers with conjugated chain structures. It will be appreciated that a conducting polymer refers to any organic polymer or organic copolymer that is capable of conducting electricity, and may for example include a polymer that is a semi-conductor. It will be appreciated that a conducting polymer may require further processing to provide desired conductance properties. An example of a conducting polymer is polyaniline. It will be appreciated that the terms “conducting polymer” or “polymer” can include one or more “copolymers”, and the term “monomer” can include one or more comonomers.

The conducting polymer may have a linear backbone. The conducting polymer may be selected from the group consisting of a polyarylamine, polyarylthiol, polypyrrole, polycarbazole, polyindole, polyazepine, polythiophene, and poly(3,4-ethylenedioxythiophene). In at least some examples, the conducting polymers can be selected to provide for further improved processability. In at least some examples, polyaniline polymers provide improved conductivity. It will be appreciated that the conducting polymer includes any salts thereof, such as those formed by reaction with an acid, for example a protonic acid. The conducting polymer can comprise, or be a reaction product of, an unsubstituted or substituted monocyclic, bicyclic, or tricyclic hetaryl monomer comprising at least one annular heteroatom selected from nitrogen and sulphur. The conducting polymer can comprise, or be a reaction product of, an unsubstituted or substituted monocyclic, bicyclic, or tricyclic aryl monomer comprising at least one exocyclic heteroatom selected from nitrogen and sulphur. For example, the conducting polymer can comprise, or be a reaction product of, an unsubstituted or substituted monocyclic aryl monomer comprising at least one exocyclic heteroatom selected from nitrogen and sulphur. In an example, the conducting polymer comprises or consists of a polymerised monocyclic monomer having a single aromatic ring. In another example, the polymerised monocyclic monomer having a single aromatic ring comprises at least one exocyclic heteroatom selected from nitrogen and sulphur. It will be appreciated that the reaction products can involve reaction with a protonic acid and free radical initiator. To achieve an increased conductivity in conducting polymers, a counter ion may be introduced by protonation and/or redox reaction.

In another example, the conducting polymer comprises, or is a reaction product of, an unsubstituted or substituted monocyclic, bicyclic, or tricyclic hetaryl monomer and/or an unsubstituted or substituted monocyclic aryl monomer. The hetaryl monomer may comprise at least one annular heteroatom selected from nitrogen and sulphur. The aryl or hetaryl monomer may comprise at least one exocyclic heteroatom selected from nitrogen and sulphur. In another example, the conducting polymer comprises, or is a reaction product of, an unsubstituted or substituted monocyclic hetaryl or aryl monomer.

Polypyrrole and polyazepine are examples of conducting polymers prepared from a reaction product of a monocyclic hetaryl comprising at least one heteroatom selected from nitrogen. Polyindole is an example of a conducting polymer prepared from a reaction product of a bicyclic hetaryl comprising at least one heteroatom selected from nitrogen. Polycarbazole is an example of a conducting polymer prepared from a reaction product of a tricyclic hetaryl comprising at least one heteroatom selected from nitrogen. A polyarylamine, such as polyaniline, is an example of a conducting polymer prepared from a reaction product of a monocyclic aryl monomer comprising at least one exocyclic heteroatom selected from nitrogen. Polythiophene is an example of a conducting polymer prepared from a reaction product of a monocyclic hetaryl comprising at least one heteroatom selected from sulphur. Poly(3,4-ethylenedioxythiophene) is an example of a conducting polymer prepared from a reaction product of a bicyclic hetaryl comprising at least one heteroatom selected from sulphur. Polyphenylene sulfide is an example of a conducting polymer prepared from a reaction product of a monocyclic aryl monomer comprising at least one exocyclic heteroatom selected from sulphur.

In one example, the conducting polymer is a polyarylamine, for example polyaniline. The polyarylamine may comprise, or be a reaction product of, an unsubstituted or substituted monocyclic, bicyclic, or tricyclic hetaryl monomer and/or an unsubstituted or substituted monocyclic aryl monomer. The hetaryl monomer may comprise at least one annular heteroatom selected from nitrogen and sulphur. The aryl monomer may comprise at least one exocyclic heteroatom selected from nitrogen and sulphur. In another example, the polyarylamine comprises, or is a reaction product of, an unsubstituted or substituted monocyclic hetaryl or aryl monomer.

The conducting polymer may be a base or salt, for example a polyaniline emeraldine salt. The conducting polymer salt may be selected from a phosphorus or sulphur containing salt. In one example the conducting polymer salt is a sulfonate salt. The salt may be a dinonylnapthalenesulfonate (DNNSA), methanesulfonate (MSA), camphorsulfonate (CSA), p-toluenesufonate (TSA), dodecyl benzene sulfonate (DBSA), dinonylnapthalene sulfonate (DNNSA), or combinations thereof. In one example, the conducting polymer salt is a dinonylnapthalene sulfonate salt (DNNSA).

In another example the conducting polymer salt is a phosphorus containing salt. The conducting polymer salt may be a phosphonate salt or a phosphonate salt. In some embodiments or examples, the phosphonate salt may be derived from phosphonic acids such as phenylphosphinic acid, styrilphosphonic acid, 2-chloroethyl-phosphonic acid, n-decylphosphonic acid, n-benzylphosphonic acid, n-butylphosphonic acid, aminotris(methylene phosphonic acid). In some embodiments or examples, the phosphonate salt may be derived from diesters of phosphoric acid (e.g. (2-methylpropyl) hydrogen phosphate (DiBHP), bis(2-ethylhexyl) hydrogen phosphate (DiOHP) and its non-branched analogue, and bis(n-octyl) hydrogen phosphate (DnOHP)). In some embodiments or examples, the phosphonate salt may be a phenylphosphonate, styrilphosphonate, 2-chloroethyl-phosphonate, n-decylphosphonate, n-benzylphosphonate, n-butylphosphonate, aminotris(methylene phosphonate, (2-methylpropyl) hydrogen phosphonate, bis(2-ethylhexyl) hydrogen phosphonate, and bis(n-octyl) hydrogen phosphonate, or combinations thereof.

In another example, the conducting polymer salt is an organic solvent soluble conducting polymer salt. The organic solvent soluble conducting polymer salt may be provided wherein at least 0.1. 0.5, 1, 5, 10, 25, or 50 g of the conducting polymer salt is soluble in 100 mL of an organic solvent (e.g. toluene), when measured at standard room temperature and pressure.

The polyaniline base or salt may be further processed into a polyaniline emeraldine base or salt. At least according to some embodiments or examples as described herein, may be a polyaniline emeraldine base or polyaniline emeraldine salt. The polyaniline salt may be polyaniline hydrochloric acid. The polyaniline salt may be a polyaniline sulfonate salt. The polyaniline salt can be a sulfonate, for example where the acid is dinonylnapthalenesulfonic acid (DNNSA). In an embodiment or example, the polyaniline salt can be a sulfonate where the sulfonic acid may be methanesulfonic acid (MSA), camphorsulfonic acid (CSA), p-toluenesufonic acid (TSA), dodecyl benzene sulfonic acid (DBSA), dinonylnapthalene sulfonic acid (DNNSA), or combinations thereof. The conducting polymer may be polyaniline methanesulfonate salt (PANI-MSA). The conducting polymer may be polyaniline camphorsulfonate salt (PANI-CSA). The conducting polymer may be polyaniline p-toluenesufonate salt (PANI-TSA). The conducting polymer may be polyaniline dodecyl benzene sulfonate salt (PANI-DBSA). The conducting polymer may be polyaniline dinonylnapthalene sulfonate salt (PANI-DNNSA).

### Polyaniline

An aniline monomer can be polymerised to form polyaniline. Polyaniline can be in three potential oxidation states: leucoemeraldine (white), emeraldine (green), and pernigraniline (blue/violet). The repeat unit of Formula 1 below provides x as half a degree of polymerization.

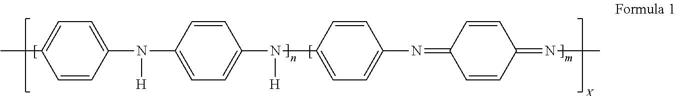

Leucoemeraldine is a fully reduced state (e.g. n=1, m=0). Pernigraniline is a fully oxidized state with imine links instead of amine links (n=0, m=1). The polyaniline can be in one of these three states or a mixture thereof. The emeraldine form of polyaniline (n=m=0.5), is referred to as emeraldine base (EB), if neutral, although when protonated is called emeraldine salt (ES), with the imine nitrogens protonated by an acid. Protonation facilitates delocalising the otherwise trapped diiminoquinone-diaminobenzene state. Emeraldine base is the preferred form of polyaniline because of its typical high stability at room temperature and on protonation to provide the emeraldine salt form, has high electrical conductivity.

### Polyphenylene Sulfide

The conducting polymer may be a polyphenylene sulfide. Polyphenylene sulfide is an organic polymer comprising of aromatic rings linked with sulphide moieties. The repeat unit of Formula 2 below provides one example of a repeating unit of polyphenylene sulfide.

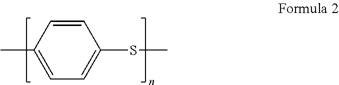

Polyphenylene sulfide can be converted to the semiconducting form by oxidation or use of various dopants. Polyphenylene sulfide also offers high temperature resistance, chemical resistance, flowability, dimensional stability and electrical characteristics.

### Polypyrrole

A pyrrole monomer can be polymerised to form polypyrrole. Polypyrrole is a conducting polymer. The repeat unit of Formula 3 below provides one example of a repeating unit of polypyrrole.

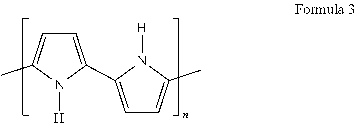

Polypyrrole in its oxidized form is a good electrical conductor. Higher conductivities can be achieved by doping polypyrrole with large anions, such as tosylate.

### Polycarbazole

A carbazole monomer can be polymerised to form polycarbazole. Polycarbazole is an electrically conducting polymer in its oxidised state. The repeat unit of Formula 4 below provides one example of a repeating unit of polycarbazole.

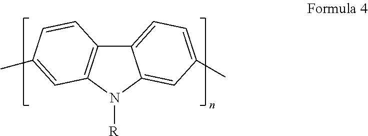

When the nitrogen of the polycarbazoles is oxidised prior to the backbone, which can create a high localised charge and good electrical conducting properties.

### Polyindole

An indole monomer can be polymerised to form polyindole. Polyindole is a conductive polymer containing a benzene ring linked with a pyrrolitic ring. The repeat unit of Formula 5 below provides one example of a repeating unit of polyindole.

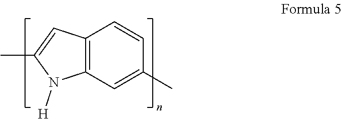

### Polyazepine

An azepine monomer can be polymerised to form polyazepine. The repeat unit of Formula 6 below provides one example of a repeating unit of polyazepine.

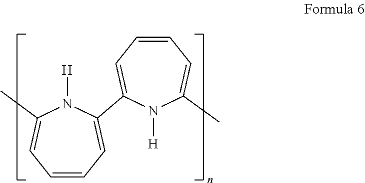

### Polythiophene

A thiophene monomer can be polymerised to form polythiophene. Polythiophene becomes conductive when oxidised. The repeat unit of Formula 7 below provides one example of a repeating unit of polythiophene.

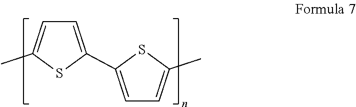

The electrical conductivity of polythiophene results from the delocalisation of electrons along the polythiophene backbone. Polythiophene also has good optical properties which respond to various environmental stimuli, and include colour shifts in response to changes in solvent, temperature and applied potential. Both colour changes and conductivity changes are induced by the twisting of the polymer backbone, disrupting conjugation.

Poly(3,4-ethylenedioxy)thiophene

A 3,4-ethylenedioxythiophene monomer can be polymerised to form poly(3,4-ethylenedioxythiophene). Poly(3,4-ethylenedioxythiophene) is a transparent conducting polymer, which can be employed in liquid crystal displays (LCDs) and solar cells. The repeat unit of Formula 8 below provides one example of a repeating unit of poly(3,4-ethylenedioxythiophene).

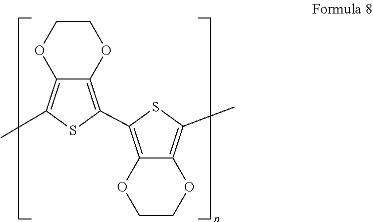

Poly(3,4-ethylenedioxythiophene) has good optical transparent properties in its conducting state, high stability and a moderate band gap and low redox potential.

Poly(3,4-propylenedioxy)thiophene A 3,4-propylenedioxythiophene monomer can be polymerised to form poly(3,4-propylenedioxythiophene). Poly(3,4-propylenedioxythiophene) is a transparent conducting polymer with applications in electrochromic devices. The repeat unit of Formula 9 below provides one example of a repeating unit of poly(3,4-propylenedioxythiophene).

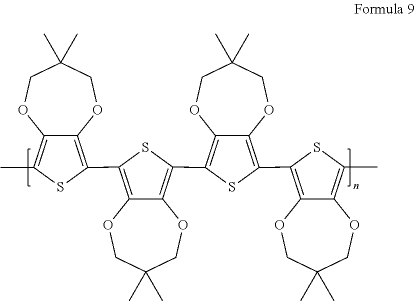

Poly(3,4-propylenedioxythiophene) has excellent optical and electrochromic properties as well as good processability and solubility.

In some embodiments or examples, each individual polymerised chain of the conducting polymer, or any salt thereof, may be independently comprised of individual monomer units of between about 100 to 1500. The number of individual monomer units may be at least about 100, 200, 300, 400, 500, 600, 700, 800, 900, 1000, 1100, or 1200. The number of individual monomer units may be less than about 1500, 1400, 1300, 1200, 1100, 1000, 900, 800, 700, 600, or 500. The number of individual monomer units may be between about 300 to 1400, 500 to 1300, 600 to 1200, or 700 to 1100. The number of individual monomer units in an individual polymerised chain may be in a range provided by any lower and/or upper limit as previously described.

The conducting polymer or salt thereof may have a number average molecular weight of at least 10,000. For example, number average molecular weight may be at least about 20,000, 30,000, 40,000, 50,000, 60,000, 70,000, or 80,000. The number average molecular weight may be in a range of about 10,000 to 120,000, 20,000 to 115,000, 30,000 to 110,000, 40,000 to 105,000, 50,000 to 100,000, or 60,000 to 100,000. The number average molecular weight may be less than about 120,000, 110,000, 100,000, 90,000, 80,000, 70,000, 60,000, 50,000, or 40,000. The number average molecular weight may be in a range provided by any lower and/or upper limit as previously described.

It will be appreciated that the conducting polymer described herein, such as polyaniline, may allow versatility in application of the end product graphitic material. For example, a polyaniline sulfonate salt is particularly suitable for providing controlled production of graphitic material. It will be appreciated that the process for producing graphitic material as described in the present disclosure can provide a cost-effective scalable process for obtaining graphitic material having advantageous properties of functionality and dispersibility.

It will be appreciated that the conducting polymer of the present invention may be provided in a high purity. In an embodiment or example, the purity of conducting polymer may be in a range from about (by weight %) 70 to 99, about 75 to 98, about 80 to 97, about 85 to 96, about 90 to 95. The purity of conducting polymer may be at least (by weight %) 70, 75, 80, 85, 90, 95, or 99. The purity of the conducting polymer may be less than about (by weight %) 99, 98, 97, 96, 95, 90, 85, 80, 75. The purity of conducting polymer may be in a range provided by any lower and/or upper limit as previously described. It will be appreciated that the conducting polymer may be dissolved or dispersed in an organic solvent for coating on a substrate. In other words the conducting polymer is present in a solid phase and at least according to some embodiments or examples is capable of being dissolved or dispersed in an organic solvent such that the conducting polymer can be applied or coated onto a scaffold or substrate and then heated to form a scaffold or substrate coated with the graphitic material.

In an embodiment or example, the coated substrate comprising the conducting polymer may have residual organic solvent, for example in an amount of less than (by weight %) 8, 7, 6, 5, 4, 3, 2, or 1. The amount of residual organic solvent may be (by weight %) at least 1, 2, 3, 4, 5, 6, 7, or 8. The amount of residual organic solvent may be in a range provided by any lower and/or upper limit as previously described. In an embodiment or example, the conducting polymer may have residual monomer in an amount of less than (by weight %) 5, 4, 3, 2, 1, or 0.5.

At least according to some embodiments or examples, the ratio of sulphur to nitrogen (S/N ratio) when present for the conducting polymer may be in a range of about 0.1 to 0.5, 0.15 to 0.45, or 0.2 to 0.4. The S/N ratio may be less than 0.5, 0.45, 0.4, 0.35, 0.3, or 0.25. The S/N ratio may be at least 0.2, 0.25, 0.3, 0.35, 0.4, 0.45 or 0.5. The S/N ratio may be in a range provided by any lower and/or upper limit as previously described. For example, the S/N ratio for polyaniline sulphonate salt may be in a range of about 0.1 to 0.5, 0.15 to 0.45, or 0.2 to 0.4. The S/N ratio for polyaniline sulphonate salt may be less than 0.5, 0.45, 0.4, 0.35, 0.3, or 0.25. The S/N ratio for polyaniline sulphonate salt may be at least 0.2, 0.25, 0.3, 0.35, 0.4, 0.45 or 0.5. The S/N ratio for polyaniline sulphonate salt may be in a range provided by any lower and/or upper limit as previously described.

### Environment

At least according to some embodiments or examples as described herein, the method of preparing the graphitic material from the conducting polymer via a heating process may be carried out in a controlled environment. For example, the controlled environment may be a furnace. It will be appreciated that other heating methods may be used whereby the method is carried out in a controlled environment. For example, the heating method may be selected from any one of flash pyrolysis, flash vacuum pyrolysis, laser pyrolysis, or microwave pyrolysis.

In some embodiments or examples, the controlled environment may be air or inert gas. The inert gas may be selected from any one of nitrogen, helium or argon. The inert gas may be selected from nitrogen or argon. In a preferred embodiment, the inert gas is nitrogen. In some embodiments or examples, the controlled environment may be at atmospheric pressure or vacuum. In some embodiments or examples the controlled environment may also be used to provide a cooling step according to any embodiment or example thereof as described herein.

In some embodiments or examples, the inert gas flow rate may be in a range between about 0.5 L/min to about 30 L/min. The inert gas flow rate may be in a range from between about 1 L/min and 20 L/min, about 1.5 L/min and 15 L/min, or about 2 L/min and 10 L/min. The inert gas flow rate may be less than about 30 L/min, less than about 25 L/min, less than about 20 L/min, less than about 15 L/min, less than about 10 L/min, or less than about 5 L/min. The inert gas flow rate may be at least about 0.5 L/min, at least about 1 L/min, at least about 1.5 L/min, at least about 2 L/min, at least about 2.5 L/min, at least about 3 L/min, at least about 3.5 L/min, at least about 4 L/min, at least about 5 L/min, or at least about 10 L/min. The inert gas flow rate may be provided in a range between any two of these previously described upper and/or lower values. At least according to some embodiments or examples, the inert gas flow rates can provide further advantages in facilitating higher N and/or O content, and/or lower S content, in the graphitic material.

In another example, the oxygen level in the controlled environment (by volume %) may be maintained below about 2%, for example below about 1%, 0.1%, 0.01%, or 0.001%.

### Graphitic Material

The present disclosure provides a process for preparing a graphitic material by heating a conducting polymer, to a predetermined temperature. The inventors found that the end product graphitic material demonstrated unexpected enhanced properties. It is believed that the enhanced properties of the graphitic material are related to the structural changes and morphologies obtained from the formation of graphitic material formed by heating the conducting polymer. The structural changes and morphologies can be analysed through conductivity, thermogravimetric analysis, x-ray photoelectron spectroscopy, Raman spectroscopy, and scanning electron microscopy. X-ray fluorescence (XRF) may be used to analyse structural changes and morphology of the graphitic material, i.e. to determine the composition of any trace elements present in the graphitic material. Elemental microanalysis may also be used to obtain bulk elemental content.

It will be appreciated that x-ray photoelectron spectroscopy (XPS) may provide information relating to the surface elemental composition of the graphitic material. The XPS may also provide information relating to the particular chemical species present on the surface of the graphitic material. The present disclosure provides a graphitic material that may comprise or consist of a heteroatom, including for example, nitrogen, oxygen, sulphur, or combinations thereof. In an embodiment or example, the content of nitrogen may be in an amount of about 0.2% to about 20%. The content of oxygen may be in an amount of about 0% to about 20%. The content of sulphur may be in an amount of about 0% to about 20%.

In some embodiments or examples, the content of nitrogen may be in a range selected from between about 0.5% and 15%, about 1.0% and 12%, about 2.0% and 10%, about 3.0% and 8.0%, or about 5% and 7.5%. For example, the content of nitrogen may be in the range of about 3.0% and 6.0%. The content of nitrogen may be less than about, 20%, less than about 19%, less than about 18%, less than about 17%, less than about 16%, less than about 15%, less than about 14%, less than about 13%, less than about 12%, less than about 11%, less than about 10%, less than about 9.5%, less than about 9.0%, less than about 8.5%, less than about 8.0%, less than about 7.5%, less than about 7.0%, less than about 6.5%, or less than about 6.0%. The content of nitrogen may be at least about 0.5%, at least about 1.0%, at least about 1.5%, at least about 2.0% at least about 2.5%, at least about 3.0%, at least about 3.5%, at least about 4.0%, at least about 4.5%, at least about 5.0%, at least about 5.5%, at least about 6.0%, at least about 6.5%, at least about 7.0%, at least about 7.5%, at least about 8.0%, at least about 8.5%, at least about 9.0%, at least about at least about 9.5%, at least about 10%, at least about 11%, at least about 12%, at least about 13%, at least about 14%, at least about 15%, at least about 16%, at least about 17%, at least about 18%, or at least about 19%. The content of nitrogen may be in a range provided by any lower and/or upper limit as previously described.

In some embodiments or examples, the content of oxygen may be in a range selected from between about 0.4% and 18%, about 0.6% and 12%, about 0.8% and 8.0%, or about 1.0% and 6.0%. For example, the content of oxygen may be in a range of about 1.0% and 10%. In an example, the content of oxygen may be in a range of about 1.0% and 2.0%. The content of oxygen may be less than about 20%, less than about 18%, less than about 16%, less than about 14%, less than about 12%, less than about 10%, less than about 9.0%, less than about 8.0%, less than about 7.0%, less than about 6.0%, less than about 4.0%, less than about 2.0%, or less than about 1.0%. The content of oxygen may be at least about 0.4%, at least about 0.6%, at least about 0.8%, at least about 1.0%, at least about 2.0%, at least about 3.0%, at least about 4.0%, at least about 6.0%, at least about 8.0%, at least about 10%, at least about 12%, at least about 14%, at least about 16%, or at least about 18%. The content of oxygen may be in a range provided by any lower and/or upper limit as previously described.

In some embodiments or examples, the content of sulphur may be in a range selected from between about 0.01% and 18%, about 0.02% and 12%, about 0.03% and 8.0%, about 0.04% and 2.0%, about 0.05% and 0.6%, about 0.06% and 0.4%, or about 0.07% and 0.2%. For example, the content of sulphur may be in a range of between about 0.01% and 1.0%. In an example, the content of sulphur may be in a range of between about 0% and 5.0%. In another example, the content of sulphur may be in a range of between about 0% and 0.2%. The content of sulphur may be less than about 18%, less than about 15%, less than about 12%, less than about 10%, less than about 8.0%, less than about 6.0%, less than about 4.0%, less than about 2.0%, less than about 1.5%, less than about 1.0%, less than about 0.5%, less than about 0.1%, less than about 0.05%, less than about 0.01%, less than about 0.005%, or less than about 0.001%. In one example, the content of sulphur is less than about 2.0%. In another example, the content of sulphur may be less than about 0.2%. The content of sulphur may be at least 0.0001%, at least 0.001%, at least 0.005%, at least 0.01%, at least 0.02%, at least about 0.04%, at least about 0.06%, at least about 0.08%, at least about 1.0% at least about 2.0%, at least about 3.0%, at least about 4.0%, at least about 6.0%, at least about 8.0%, at least about 10%, at least about 12%, at least about 14%, at least about 16%, or at least about 18%. The content of sulphur may be in a range provided by any lower and/or upper limit as previously described.

It will be appreciated that trace materials may be present in the conducting polymer or graphitic material. The trace materials as described herein may be trace materials present in the conducting polymer or graphitic material in trace amounts. It will be appreciated that the content of any trace materials if present, may be less than (in ppm) 50,000, 20,000, 10,000, 5000, 2000, 1000, 500, 200, 100, 50, 10, 5, or 1. For example, the trace materials may be present in a concentration of less than 150 ppm. In one example, the content of trace materials in the conducting polymer or graphitic material is less than about 50 ppm. For example, the trace materials may be metals, halides, silicon, phosphorous, sulphur, arsenic, selenium, or combinations thereof, present in the conducting polymer or graphitic material. It will be appreciated that any reference to “trace” materials, such as “trace metals” present in graphitic material relate to the trace metal content in the graphitic material, and does not relate to the catalytic material or any precursors thereof that form interspersed particles on the surface of the graphitic material. The trace metals may be iron, sodium, magnesium, aluminium, potassium, calcium, scandium, titanium, vanadium, chromium, manganese, cobalt, nickel, copper, zinc, gallium, germanium, molybdenum, or combinations thereof. For example, the content of trace metals, if present, in the conducting polymer or graphitic material may be less than (in ppm) 200, 150, 100, 90, 80, 70, 60, 50, 40, 30, 20, 10, 5 or 1. The trace halides may be fluoride, chloride, bromide, iodide, or combinations thereof. The trace halides may be chloride, bromide, iodide, or combinations thereof. For example, the content of trace halides, if present, in the conducting polymer or graphitic material may be less than (in ppm) 50, 45, 40, 35, 30, 25, 20, 15, 10, 5, or 1. In one example, the content of trace silicon, if present, in the conducting polymer or graphitic material may be less than (in ppm) 100, 50, 20, 15, 10, 5, 2, or 1. In another example, the content of trace sulphur, if present, in the conducting polymer may be less than (in ppm) 50,000, 20,000, 10,000, 5000, 2000, 1000, 500, 200, 100, 50, 10, 5, or 1. In another example, the content of trace sulphur, if present, in the graphitic material may be less than (in ppm) 2000, 1800, 1600, 1400, 1200, 1000, 500, 100, 50, 20, 10, 5, or 1.

The heteroaryl or heteroatom content may be controlled by the process parameters as described herein for the preparation of graphitic material, for example, the conducting polymer starting material and/or the predetermined temperature.

In some embodiments or examples, the heteroatom content may be controlled by heating the graphitic material to a temperature of between about 350° C. to about 2200° C. The temperature may be at least about 350° C., at least about 450° C., at least about 550° C., at least about 650° C., at least about 750° C., at least about 850° C., at least about 950° C., at least about 1200° C., at least about 1500° C., or at least about 1800° C. The temperature may be less than about 2200° C., less than about 1800° C., less than about 1500° C., less than about 1200° C., or less than about 1000° C. In an example, the heteroatom content may be controlled by heating the graphitic material to a temperature of between about 600° C. to about 1200° C. In another example, the heteroatom content may be controlled by heating the graphitic material to a temperature of between about 800° C. to about 1200° C. The temperature may be in a range provided by any lower and/or upper limit as previously described.

Without wishing to be bound by theory it is believed that, as the conducting polymer (e.g. polyaniline salt) is subjected to the heating process, molecules of conducting polymer react to form a 2-dimensional polyaryl or polyheteroaryl sheet-like network containing bridged aryl and hetaryl rings. Since the conducting polymers comprise heteroatoms (e.g. nitrogen, oxygen, sulphur), it is also considered that the 2-dimensional network containing ring structures may also contain heteroatoms within that 2-dimensional material. Thus, in some embodiments or examples, the graphitic material described herein may comprise or consist heteroatomic content, e.g. within the 2-dimensional network of rings. For example, the graphitic material as described herein may comprise or consist of heteroatoms within the plane of the 2-dimensional network of rings. In another example, the graphitic material as described herein may comprise or consist of heteroatoms on the edge of the sheet or holes in the 2-dimentsional network of rings. For example, the graphitic material according to at least some examples or embodiments as described herein may be generally represented by the portion of structure as shown below in Formula 10.

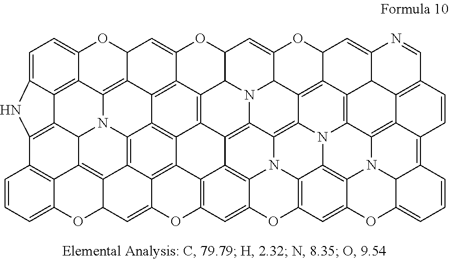 [SMILES: C1=CC2=c3ccc4c5c3=c3c6c7c8c9c%10c%11c%12c%13c%14c%15c%16c%17c%18c%19n%20c%21c%22c%23c(oc%24cc%25oc%26cc%27c(c(c%26n%11c%25c%13c%24c%23c%14c%17%21)n6%10)n3C2C(=C1)O%27)=CC1Oc2cccc3c2C(=C%221)C%20c1c-3[nH]c2ccc(c-%19c12)OC%18C=C%16OC1C=C(OC8C=C(N=C4)C57)C9N%12C%151]

In some embodiments or examples, the graphitic material, as described herein, may comprise or consist of an inherent heteroatomic content. The term “inherent” as used herein refers to a characteristic attribute that is intrinsic of the conducting polymer. In one example, the heteroatom content is provided by the inherent heteroatom content of the conducting polymer. In other words, in one example there is a method with the proviso that there is no doping to modify or increase the heteroatom content of the graphitic material. It will be appreciated that the formation of the graphitic material described herein does not utilise known processes such as in-situ polymerisation or chemical vapour deposition (CVD).

It will be appreciated that the graphitic material may be a 2-dimensional network that contains a conjugated or π system formed from heating the conducting polymer. In one example, the graphitic material may comprise or consist one or more layers. For example the graphitic material may be a sheet that comprises or consists one or more layers that may be stacked together. The sheet may be a continuous sheet. The graphitic material may comprise or consist of one or more layers of a continuous sheet. It will be appreciated that the term “sheet” excludes cylindrical nanostructures such as fullerenes that are in the form of a sphere, ellipsoid, and/or tubes. For example, the term “sheet” excludes single-walled nanotubes (SWNTs) and multi-walled nanotubes (MWNTs), or other cylindrical nanostructures formed from complex multi-step processes. It will be appreciated that heating or subjecting the conducting polymer to a predetermined temperature, the end product graphitic material may inherently comprise or consist of heteroatoms. In an embodiment or example, heating the linear conducting polymer molecules enables formation of a 2-dimensional network having ring structures containing covalently linked heteroatoms within that 2-dimensional material. Heating the linear conducting polymer molecules can enable formation of a graphitic material comprising a 2-dimensional network having a conjugated or π system comprising polyaryl groups and containing a content of heteroatoms. The polyaryl groups may be bridged and linked together in the 2-dimensional graphitic network. In another embodiment or example, the linear backbone of the conducting polymer molecules covalently interconnects with other linear conducting polymer molecules to form a 2-dimensional honeycomb network containing heteroatoms that are covalently bonded within the network. In doing so, different types and amounts of heteroatomic bonding configurations in the graphitic material may be achieved in a controlled way.

The nitrogen heteroatom content can comprise one or more of three primary N-bonding configurations, namely graphitic nitrogen, pyridinic nitrogen and pyrrolic nitrogen. In an embodiment, the nitrogen in the graphitic material may be pyridinic nitrogen, pyrrolic nitrogen, graphitic nitrogen, or combinations thereof. Pyridinic nitrogen refers to nitrogen atoms that bond with two carbon atoms at the edges or defects of graphene and which contributes one p electron to the π system of graphene. Pyrrolic nitrogen refers to nitrogen atoms that contribute two p electrons to the π system of graphene. Graphitic nitrogen refers to nitrogen atoms that substitute for carbon atoms in the graphene matrix.

At least according to some embodiments or examples as described herein, the content of graphitic nitrogen may be in a range between about 0% to about 50% (% of total nitrogen content of the graphitic material). In some embodiments or examples, the content of graphitic nitrogen may be in a range between about 5% and 65%. In another embodiment or example, the content of graphitic nitrogen may be in a range between about 30% and 60%. In an embodiment or example, the content of graphitic nitrogen may be selected from a range of between about 1% and 60%, about 2% and 49%, about 10% and 48%, about 20% and 47%, about 25% and 46%, or about 30% and 45%. The content of graphitic nitrogen may be less than about 65%, less than about 60%, less than about 50%, less than about 45%, less than about 40%, or less than about 35%. The content of graphitic nitrogen may be at least about 10%, at least about 20%, at least about 30%, or greater than about 35%. The content of graphitic nitrogen may be in a range provided by any lower and/or upper limit as previously described. The inventors have surprisingly found that at least according to some embodiments or examples of the process as described herein that a nitrogen content in the graphitic material can be provided that predominantly consists of graphitic nitrogen, pyridinic nitrogen and pyrrolic nitrogen.

The graphitic material may be subjected to Raman spectroscopy. Raman analysis provides characteristic peaks depending of specific types of carbon present.

At least according to some embodiments or examples, the graphitic material comprises a G band, a 2D band, and optionally a D band. In some embodiments or examples, the graphitic material comprises a G band, a 2D band, and a D band which occur around 1560, 2700, and 1360 cm⁻¹ respectively. The D band, present at 1360 cm⁻¹ is referred to as a structural disorder spectrum peak, its intensity reflects the situation in disordered crystal structures. The frequency band at 1580 cm⁻¹, designated the G band, refers to monocrystalline graphite specific, graphite lattice CC bond stretching vibration of the inner surface. The degree of graphitisation is used to characterise the complete structure of the sp² hybridized bond structure. This indicates that in the Raman spectrum, there is a certain correlation between the relative disorder of the graphitic material at 1360 cm⁻¹ material and the degree of graphitisation at 1580 cm⁻¹. It will be appreciated that the more crystalline graphitic materials exhibit the 2D peak around 2700 cm⁻¹. At least according to some embodiments or examples of the process as described herein, the degree of order of carbon structures within the graphitic material can be gradually increased with increasing temperature.

In some embodiments or examples, the graphitic material may be in the form of a single layer. In another embodiment, the graphitic material may be in the form of two or more layers, such as stacked sheets. The graphitic material may comprise between about 2 to 100 layers, about 5 to 50 layers, about 10 to 25 layers, or about 15 to 20 layers. The graphitic material may comprise less than 100 layers, 80 layers, 60 layers, 40 layers, 20 layers, 10 layers, 5 layers, or less than 4 layers. The graphitic material may comprise at least about 2 layers, at least about 5 layers, at least about 10 layers, at least about 20 layers, at least about 40 layers, at least about 60 layers, or at least about 80 layers. The graphitic material may comprise layers in a range provided by any lower and/or upper limit as previously described.

It will be understood that the present disclosure provides a graphitic material that has an inherent content of heteroatoms provided by the heteroaryl groups in the conducting polymer. The inherent content of heteroatom is derived from heating the conducting polymer (e.g. polyaniline salt). During the heating process, the predetermined temperature initiates the formation of graphitic material through the carbonisation of the conducting polymer network. In an embodiment, the carbonisation of the conducting polymer, e.g. polyaniline sulfonate salt, enables the formation of a graphitic material containing inherent heteroatomic species. Advantageously, formation of the graphitic material from heating the conducting polymer, e.g. polyaniline sulfonate salt, at least according to some embodiments or examples as described herein, can improve charge transfer efficiency due to improved conductivity of the graphitic material, and can further enhance dispersibility.

It has been surprisingly found that the present disclosure provides a graphitic material having excellent conductivity. At least according to some embodiments or examples, the graphitic material may have a conductivity in a range selected from between about 0.5 S/cm and 1000 S/cm, about 2 S/cm and 800 S/cm, about 5 S/cm and 600 S/cm, about 10 S/cm and 400 S/cm, or about 20 S/cm and 200 S/cm. The conductivity of the graphitic material may be at least about 0.5 S/cm, at least about 2 S/cm, at least about 5 S/cm, at least about 10 S/cm, at least about 20 S/cm, at least about 30 S/cm, at least about 50 S/cm, at least about 100 S/cm, at least about 200 S/cm, at least about 500 S/cm, or at least about 800 S/cm. The conductivity of the graphitic material may be less than about 800 S/cm, less than about 500 S/cm, less than about 200 S/cm, less than about 100 S/cm, less than about 50 S/cm, less than about 20 S/cm, less than about 10 S/cm, or less than about 5 S/cm. The conductivity of the graphitic material may be may be in a range between any two of these previously described upper and/or lower values.

It will be appreciated that other properties may be used to define the properties of the graphitic material, for example, surface area, density and porosity. The surface area and pore size of the graphitic material can be measured using the Brunauer-Emmett-Teller (BET) method and determined by degassing the samples at 250° C. for 16 hours prior to analysis. The BET surface areas were determined from the adsorption and desorption isotherms of nitrogen at −196° C. using a Quantachrome Autosorb-1 volumetric adsorption system. The packed or particle density of the graphitic material can also be measured. It will also be appreciated that these properties can be controlled and dictated by various factors, such as the conducting polymer, which can allow for versatility in its application. Without wishing to be bound by theory, properties such as surface area, pore density and porosity can vary by orders of magnitude depending on their degree of stacking, crumpling, pillaring, and their heteroatom and defect content.

In some embodiments or examples, the surface area of the graphitic material may be in a range of about 0.5 m²/g to 750 m²/g, about 1.0 m²/g to 500 m²/g, about 1.5 m²/g to 250 m²/g, about 2.0 m²/g to 100 m²/g, or about 2.5 m²/g to 50 m²/g. The surface area of the graphitic material may be at least about 0.5 m²/g, at least about 1.5 m²/g, at least about 2.0 m²/g, at least about 2.5 m²/g, at least about 5.0 m²/g, at least about 10 m²/g, at least about 50 m²/g, at least about 100 m²/g, at least about 200 m²/g, at least 300 m²/g, at least 400 m²/g, at least 500 m²/g, at least 600 m²/g, or at least 700 m²/g. The surface area of the graphitic material may be less than about 750 m²/g, less than about 500 m²/g, less than about 400 m²/g, less than about 250 m²/g, less than about 200 m²/g, less than about 150 m²/g, less than about 100 m²/g, less than about 50 m²/g, less than about 25 m²/g, less than about 10 m²/g, less than about 5 m²/g, or less than about 2 m²/g. The surface area of the graphitic material may be may be in a range between any two of these previously described upper and/or lower values.

In some embodiments or examples, the total pore volume of the graphitic material may be in a range of about 0.2 cm³/g to 10 cm³/g, about 0.3 cm³/g to 8 cm³/g, about 0.4 cm³/g to 7 cm³/g, about 0.5 cm³/g to 6 cm³/g, about 0.7 cm³/g to 5 cm³/g, about 0.8 cm³/g to 4 cm³/g, 0.9 cm³/g to 3 cm³/g, or about 1.0 cm³/g to 2.0 cm³/g. The total pore volume of the graphitic material may be at least about 0.2 cm³/g, at least about 0.5 cm³/g, at least about 1.0 cm³/g, at least about 2.0 cm³/g, at least about 4 cm³/g, at least about 6 cm³/g, or at least about 8 cm³/g. The total pore volume of the graphitic material may be less than about 9 cm³/g, less than about 7 cm³/g, less than about 5 cm³/g, less than about 3 cm³/g, less than about 1.5 cm³/g, or less than about 0.4 cm³/g. The total pore volume of the graphitic material may be may be in a range between any two of these previously described upper and/or lower values.

In some embodiments or examples, pore size of the graphitic material may be in a range of about 0.5 nm to 500 nm, about 1.0 nm to 100 nm, about 1.5 nm to 50 nm, about 2.0 nm to 25 nm, about 2.5 nm to 15 nm, or about 3.0 nm to 10 nm. The pore size of the graphitic material may be at least about 0.5 nm, at least about 1.0 nm, at least about 2.0 nm, at least about 5.0 nm, at least about 10 nm, at least about 25 nm, at least about 50 nm, at least about 100 nm, at least about 200 nm, or at least about 400 nm. The pore size of the graphitic material may be less than about 500 nm, less than about 300 nm, less than about 200 nm, less than about 150 nm, less than about 80 nm, less than about 40 nm, less than about 30 nm, less than about 20 nm, less than about 15 nm, less than about 10 nm, less than about 8 nm, less than about 4 nm, or less than about 2 nm. The pore size of the graphitic material may be may be in a range between any two of these previously described upper and/or lower values.

### Films and Coatings

The present disclosure provides a graphitic film or coating that may be formed by spin coating or dip coating the conducting polymer (e.g. polyaniline) on a substrate and then subjecting the pre-coated substrate to the heating process as described herein. Advantageously, the conducting polymer at least according to some embodiments or examples described herein is soluble in an organic solvent allowing the formation of films and coatings. For example, the conducting polymer is soluble post polymerisation. In an embodiment or example, the graphitic film or coating may be prepared comprising the steps of: (i) heating a conducting polymer to a predetermined temperature to initiate formation of a graphitic film or coating; and (ii) optionally cooling the graphitic film or coating. In a further embodiment or example, the method of preparing the graphitic film or coating may further comprise a step of (i)(a) pre-heating the conducting polymer to a predetermined temperature to produce a stabilised conducting polymer, and (i)(b) heating the stabilised conducting polymer to a predetermined temperature to initiate formation of a film or coating.

In some embodiments or examples, the solid conducting polymer material may be dissolved in an organic solvent to form a liquid conducting polymer formulation for coating the substrate. For example, a solid conductive coating may be formed on a substrate by coating the substrate with the liquid conducting formulation and drying the coated substrate to form a solid conductive material that is coated on the substrate. In another example, a liquid conductive coating may be provided on the surface of the substrate and continually heated according at least some embodiments or examples to form a graphitic material (e.g. liquid dried to provide a solid coating that undergoes solid conversion to form graphitic material without the conducting polymer forming a gaseous phase).

The spin coating method is generally a method of forming a thin film by applying a solution of the conducting polymer to the centre of substrate and high-speed spin-drying. The thickness of the thin film may be controlled by means of the concentration of the solution and the number of rotation per minute of the spin coater. The dip coating method a technique in which a substrate is dipped into a solution of the conducting polymer and dried until a constant mass is achieved. The thickness of the thin film may be controlled by means of the concentration of the solution of the conducting polymer. In one example, the graphitic material may be a uniform coating. It will be appreciated that the thickness of the graphitic film or coating depends on the application. In some embodiments, the thickness of the graphitic film or coating layer may be between about 0.1 to 15 microns, about 0.5 to 10 microns, or about 1 to 5 microns. The thickness of the graphitic film or coating layer (in microns) may be less than about 15, 14, 13, 12, 11, 10, 9, 8, 7, 6, 5, 4, 3, 2, 1, 0.5, or 0.1. The thickness of the graphitic film or coating layer (in microns) may be at least about 0.1, 0.5, 1, 2, 3, 4, 5, 6, 7, 8, 9, 10, 11, 12, 13, 14, or 15. The thickness of the graphitic film or coating layer may be in a range between any two of these previously described upper and/or lower values.

The substrate to which the conducting polymer is applied can be any substrate which is capable of withstanding the heating process employed. For example, suitable substrates include all types of glass that provide sufficient thermal stability according to the temperature applied, such as quartz glass, as well as alumina, graphite, mica, mesoporous silica, silicon wafer, nanoporous alumina or ceramic plates. In one example, the substrate is glass, in particular, fused quartz. The substrate may be a plastic. The substrate may also include any metal, metal oxide, metal alloy or compound thereof. For example, suitable metals include Al, Au, Pt, Cu, Cr, Ni, Fe, Co, Ti and Pd. In an example, the substrate may be stainless steel, in particular, 313 SS. In another example, the substrate may be a titanium alloy, in particular Ti6Al4V. In yet another example, the substrate may be a static mixer. Examples of suitable compounds are metal oxides, metal carbides, metal nitrides, metal sulfides and metal borides. Examples of suitable metal oxides include indium tin oxide (ITO), Al₂O, TiO₂ and MgO.

At least according to some embodiments or examples, the graphitic film or coating may have a conductivity in a range selected from between about 30 S/cm and 1000 S/cm, about 35 S/cm and 800 S/cm, about 40 S/cm and 600 S/cm, about 45 S/cm and 400 S/cm, or about 50 S/cm and 200 S/cm. The conductivity of the graphitic film or coating may be at least about 30 S/cm, at least about 40 S/cm, at least about 50 S/cm, at least about 100 S/cm, at least about 200 S/cm, at least about 300 S/cm, at least about 400 S/cm, at least about 500 S/cm, at least about 600 S/cm, at least about 700 S/cm, or at least about 800 S/cm. The conductivity of the graphitic film or coating may be less than about 800 S/cm, less than about 700 S/cm, less than about 600 S/cm, less than about 500 S/cm, less than about 400 S/cm, less than about 300 S/cm, less than about 200 S/cm, or less than about 100 S/cm. The conductivity of the graphitic film or coating may be may be in a range between any two of these previously described upper and/or lower values.

In some embodiments or examples, the graphitic film or coating may have a conductivity in a range selected from between about 1 S/cm and 1000 S/cm, about 5 S/cm and 800 S/cm, about 10 S/cm and 600 S/cm, about 20 S/cm and 400 S/cm, or about 50 S/cm and 200 S/cm. The conductivity of the graphitic film or coating may be at least about 1 S/cm, at least about 5 S/cm, at least about 15 S/cm, at least about 30 S/cm, at least about 40 S/cm, at least about 50 S/cm, at least about 100 S/cm, at least about 200 S/cm, at least about 300 S/cm, at least about 400 S/cm, at least about 500 S/cm, at least about 600 S/cm, at least about 700 S/cm, or at least about 800 S/cm. The conductivity of the graphitic film or coating may be less than about 800 S/cm, less than about 700 S/cm, less than about 600 S/cm, less than about 500 S/cm, less than about 400 S/cm, less than about 300 S/cm, less than about 200 S/cm, or less than about 100 S/cm. The conductivity of the graphitic film or coating may be may be in a range between any two of these previously described upper and/or lower values.

At least according to some embodiments or examples as described herein, the conducting polymer may be carried in a fluidic carrier. The conducting polymer may be suspended or dissolved in the fluidic carrier. The fluidic carrier may be a liquid. The liquid may be a solvent. Suitable exemplary liquid or solvent include aromatics, such as xylene, toluene or alkylnaphthalenes; chlorinated aromatics or chlorinated aliphatic hydrocarbons, such as chlorobenzenes, chloroethylenes or methylene chloride; aliphatic hydrocarbons, such as cyclohexane or paraffins, for example mineral oil fractions; alcohols, such as butanol, isobutanol, or glycol and also their ethers and esters, such as 2-butoxy ethanol; ketones, such as methyl ethyl ketone, methyl isobutyl ketone or cyclohexanone. It will be appreciated that the wt % of the conducting polymer is based on the wt % of the conducting polymer in solution.

It will be appreciated that the formation of the graphitic film or coating may involve the use of a previously formed solid phase conducting polymer dissolved or dispersed in an organic solvent post polymerisation. The process can enable the heating of the scaffold or substrate to which the conducting polymer is applied to directly form a graphitic film or coating on the scaffold or substrate.

### Powders and Fillers

At least according to some embodiments or examples as described herein, the present disclosure provides a graphitic material that may be a solid. The solid may be in the form of a graphitic powder or filler. The graphitic powder or filler may be prepared by the heating process as described herein. In an embodiment or example, the graphitic powder or filler may be prepared comprising the steps of: (i) heating a conducting polymer to a predetermined temperature to initiate formation of a graphitic powder; and (ii) optionally cooling the graphitic powder or filler. In a further embodiment or example, the method of preparing the graphitic powder or filler may further comprise a step of (i)(a) pre-heating the conducting polymer to a predetermined temperature to produce a stabilised conducting polymer, and (i)(b) heating the stabilised conducting polymer to a predetermined temperature to initiate formation of a graphitic powder or filler.

It will be appreciated that the particle size of the graphitic powder or filler varies depending on the application. The particle size may be intrinsic or may be altered through grinding or milling of either the conducting polymer or the graphitic powder or filler. At least according to some embodiments or examples, the graphitic powder or filler may have a particle size in a range of about 2 nm to about 1000 nm, about 4 nm to about 500 nm, about 6 nm to about 200 nm, about 8 nm to about 100 nm, or about 10 nm to about 50 nm. The graphitic powder or filler may have a particle size of less than about 100 nm, less than about 800 nm, less than about 600 nm, less than about 400 nm, less than about 200 nm, less than about 100 nm, less than about 50 nm, less than about 40 nm, less than about 30 nm, or less than about 20 nm. The graphitic powder or filler may have a particle size of at least about 2 nm, at least about 4 nm, at least about 6 nm, at least about 8 nm, at least about 10 nm, at least about 50 nm, at least about 100 nm, at least about 200 nm, at least about 300 nm, at least about 400 nm, or at least about 500 nm. The graphitic powder or filler described herein may have a particle size that may be provided in a range between any two of these previously described upper and/or lower values.

At least according to some embodiments or examples, the graphitic powder or filler may have a conductivity in a range of about 0.5 S/cm to 30 S/cm, about 0.8 S/cm and 25 S/cm, about 1.0 S/cm and 20 S/cm, or about 1.2 S/cm and 15 S/cm, about 1.5 S/cm and 10 S/cm, or about 2 S/cm and 5 S/cm. The conductivity of the graphitic powder or filler may be at least about 0.5 S/cm, at least about 1.0 S/cm, at least about 1.5 S/cm, at least about 3.0 S/cm, at least about 5.0 S/cm, at least about 8.5 S/cm, at least about 10 S/cm, at least about 12 S/cm, or at least about 15 S/cm, at least about 20 S/cm, or at least about 250 S/cm. The conductivity of the graphitic powder or filler may be less than about 30 S/cm, less than about 25 S/cm, less than about 20 S/cm, less than about 15 S/cm, less than about 10 S/cm, less than about 8 S/cm, less than about 5 S/cm, or less than about 2 S/cm. The conductivity of the graphitic powder or filler may be may be in a range between any two of these previously described upper and/or lower values.

### EXAMPLES

The present disclosure is further described by the following examples. It is to be understood that the following description is for the purpose of describing particular examples only and is not intended to be limiting with respect to the above description.

### Example 1—General Process for the Preparation of Graphitic Coating

A polyaniline base or polyaniline salt was dissolved in an organic solvent (e.g. toluene or N-Methyl-2-Pyrrolidone) and coated onto a substrate (e.g. 316 SS, Ti6Al4V or fused quartz) by dip or spin coating. The coated substrate was then dried in an oven at 100° C. in air until a constant mass was achieved. Following this the polyaniline coated substrate was transferred to a horizontal tube furnace and optionally stabilised at 280° C. under a stream of air (ramp at 5° C./min, hold for 1 h). After this time the tube furnace was purged with N_{2 (g)} and the temperature raised to 800° C. (ramp at 5° C./min, hold for 1 h) while continuing to flush with a stream of N_{2 (g)}.

The furnace was then allowed to cool to <200° C. and the coated substrate removed.

### Example 1a)

According to the general process described above, polyaniline emeraldine base was dissolved in an organic solvent. The substrate was dip or spin coated with the polyaniline emeraldine base solution and then subjected to the heating and cooling process described above.

### Example 1b)

According to the general process described above, polyaniline-MSA was dissolved in an organic solvent. The substrate was dip or spin coated with the polyaniline-MSA solution and then subjected to the heating and cooling process described above.

### Example 1c)

According to the general process described above, polyaniline-CSA was dissolved in an organic solvent. The substrate was dip or spin coated with the polyaniline-CSA solution and then subjected to the heating and cooling process described above.

### Example 1d)

According to the general process described above, polyaniline-DBSA was dissolved in an organic solvent. The substrate was dip or spin coated with the polyaniline-DBSA solution and then subjected to the heating and cooling process described above.

### Example 1e)

According to the general process described above, polyaniline-DNNSA was dissolved in an organic solvent. The substrate was dip or spin coated with the polyaniline-DNNSA solution and then subjected to the heating and cooling process described above.

### Example 2—General Process for the Preparation of a Graphitic Powder

Polyaniline base or polyaniline salt powder was subjected to the carbonisation procedure described above in example 1 to provide a grey/black graphitic powder.

### Example 2a)

A graphitic material formed from polyaniline emeraldine base was prepared according to the general process described above.

### Example 2b)

A graphitic material formed from polyaniline-MSA was prepared according to the general process described above.

### Example 2c)

A graphitic material formed from polyaniline-CSA was prepared according to the general process described above.

### Example 2d)

A graphitic material formed from polyaniline-DBSA was prepared according to the general process described above.

### Example 2e)

Prior to the general process described above, polyaniline-DNNSA (50 wt % in toluene) was concentrated under vacuum to remove the solvent. Acetone was then added to the residue in order to precipitate the polymer. This was then collected by filtration and dried in the oven at 100° C. in air until a constant mass was achieved. A graphitic material formed from polyaniline-DNNSA was prepared according to the general process described above.

### Example 3—Mechanism of Decomposition and the Dopant Effect

Thermogravimetric analysis (TGA) is a thermal analysis technique that tracks the mass of a sample over time as the temperature is changed. Specific phase transitions and thermal decomposition events can be determined through careful analysis of the TG curve while evolved gas phase species may be analysed using in-line mass spectrometry (TGA-MS).

### Example 3a)—Polyaniline-DNNSA in Air

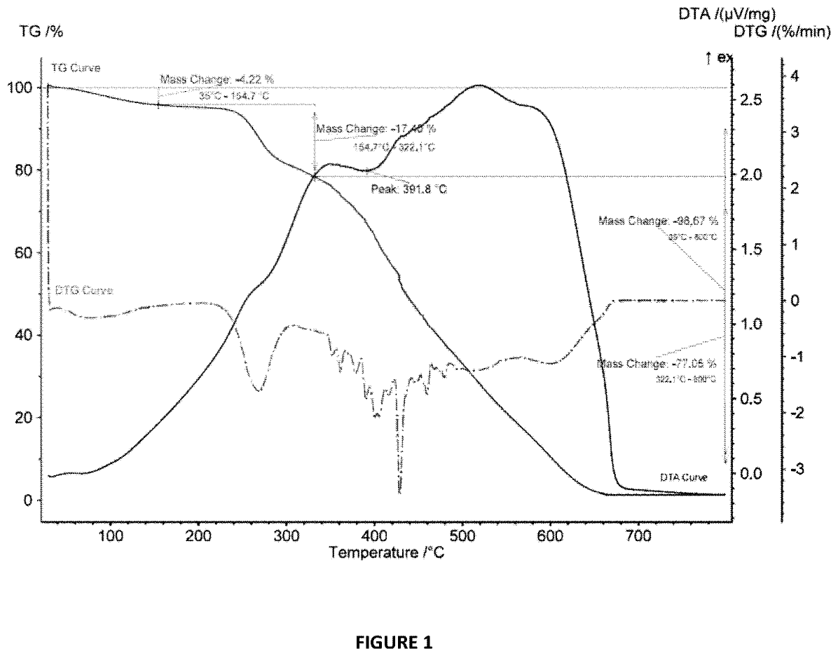

TGA of polyaniline-DNNSA in air at 5° C./min to 800° C. shows a 99% mass loss (FIG. 1). This indicates that the carbonisation process should be carried out under an inert atmosphere.

Polyaniline-DNNSA is stable up to 200° C. in air after which the DNNSA begins to decompose. At this point the conductivity of any polyaniline-DNNSA coatings would be expected to decrease as loss of DNNSA occurs before final breakdown of the PANI backbone.

### Example 3b)—Polyaniline-DNNSA in N_{2 (g)}

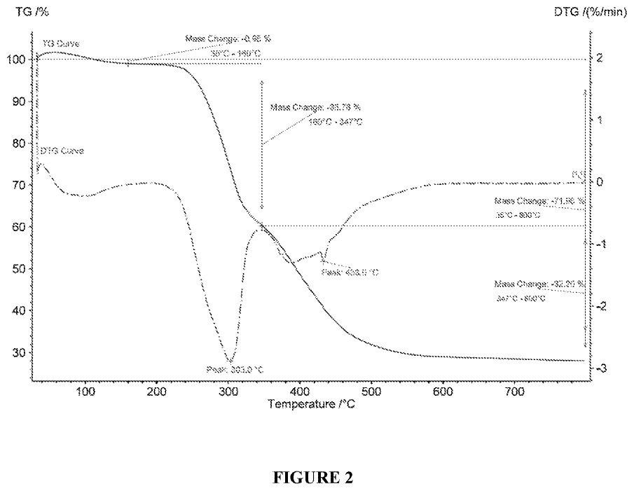

TGA of polyaniline-DNNSA under N_{2 (g)} ramping at 5° C./min to 800° C. shows a 72% mass loss (FIG. 2). A number of key mass loss events can be identified from the TG curve and the DTG curve (this is the first differential of the TG curve).

An initial mass change of 1% occurs from 35-160° C. due to loss of H₂O from the polymer (mz=18 confirmed by TGA-MS).

This is followed by a second 39% mass loss event from 160-347° C. peaking at 303° C. and third 32% mass loss event from 347-800° C. peaking at 433° C.

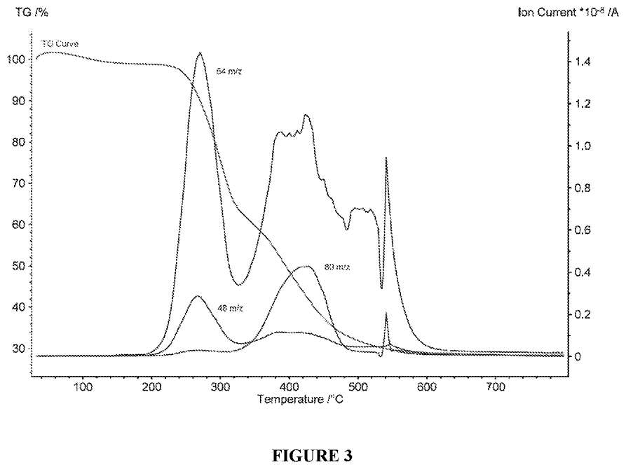

The TGA-MS data indicate that the second and third mass change events are both associated with loss of the DNNSA (FIG. 3). This occurs in two steps with both being seen through the evolution of SO (m/z 48), SO₂ (m/z 64) and SO₃ (m/z 80) detected from 200-600° C.

As the loss of these species ceases at 600° C. it is believe that the DNNSA is completely removed from the polyaniline. From then on the TG curve flattens out and remains stable for 3 hours. This suggests that any further transformations either involve internal rearrangement (i.e. crosslinking) or require higher temperatures to proceed further.

### Example 3c)—TGA Results Summary for all Polyaniline Species

The process described above in example 3b) is repeated for each of the polyaniline species with the results summarised in table 1.

TABLE 1
TGA data for the carbonisation of polyanilines ramping
at 5° C./min to 800° C. under N_{2(g)}.

| | Decomposition | Total Mass Loss |
|---|---|---|
| PANI type | Onset (° C.) | (%) |
| PANI-base | 340 | 54 |
| PANI-MSA | 160 | 48 |
| PANI-CSA | 160 | 50 |
| PANI-DBSA | 180 | 62 |
| PANI-DNNSA | 180 | 72 |

Onset of decomposition occurred for a lower temperature with polyaniline-MSA and polyaniline-CSA as compared with polyaniline-DBSA and polyaniline-DNNSA.

Polyaniline base is the free base species and as such the onset of decomposition only occurs at the temperature at which the polymer backbone starts to break down.

### Example 3d)—Calculation of Mass Balance

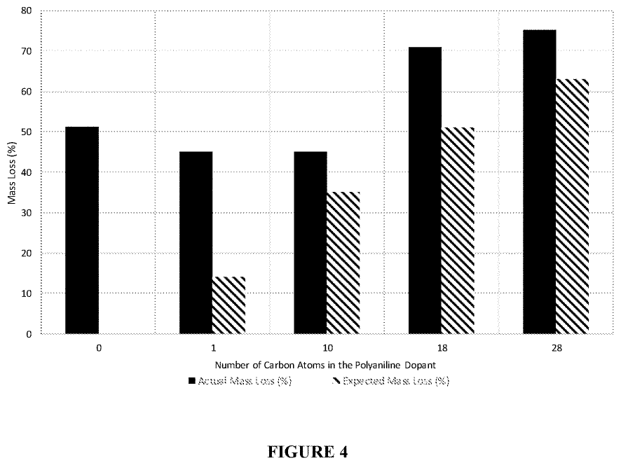

A mass balance is calculated for each polyaniline based on the carbonisation of the graphitic powder under the same conditions used in the TGA (see Table 2 and FIG. 4). There is good agreement between the experimentally derived mass loss data and the TGA data.

TABLE 2
Experimentally derived mass loss data for different polyaniline species.

| | # of C atoms in | | | | |
|---|---|---|---|---|---|
| PANI | the sulphonic | Measured | Actual Mass | Expected | |
| species | acid | S/N | Loss (%) | Mass Loss (%) | Difference |
| PANI-base | 0 | 0.007 | 51 | 0 | 51 |
| PANI-MSA | 1 | 0.209 | 45 | 14 | 31 |
| PANI-CSA | 10 | 0.277 | 45 | 35 | 10 |
| PANI-DBSA | 18 | 0.457 | 71 | 51 | 20 |
| PANI-DNNSA | 28 | 0.439 | 75 | 63 | 12 |

As show in Table 2 above, the expected mass loss data is based on complete loss of the sulphonic acid with no loss of mass due to decomposition of the polyaniline backbone.

For polyaniline-EB, 51% of the original sample mass was lost upon carbonisation despite no sulphonic acid being present. This indicates that the loss was entirely derived from decomposition of the polymer backbone.

Interestingly, as the weight of the sulphonic acid is increased the difference between the expected mass loss and the actual mass loss decreases.

For polyaniline-DNNSA the loss of mass is almost entirely accounted for by loss of the DNNSA suggesting that the sulphonic acid may play a role in protecting the polyaniline backbone or that some of the sulphonic acid is incorporated into the final carbonised product.

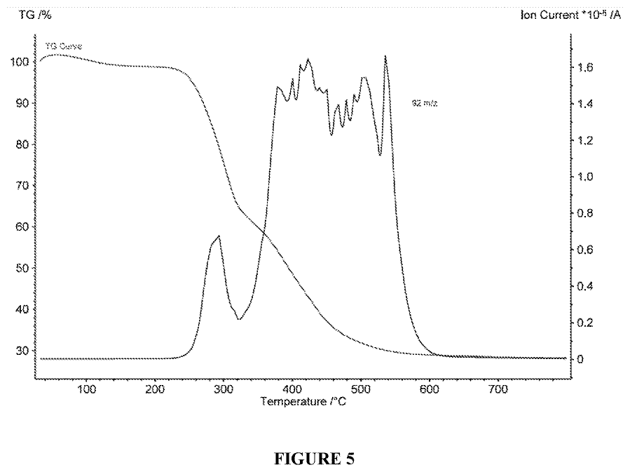

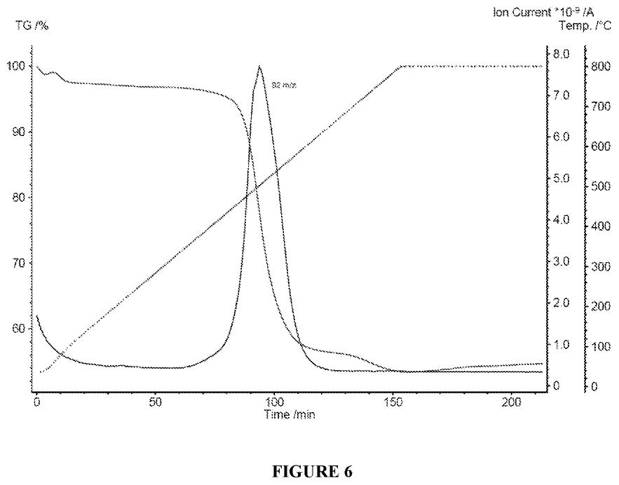

Once the sulphonic acid loss has peaked (T=303° C.) the next major decomposition event appears to be associated with depolymerisation of the polyaniline backbone. It appears that one of the main species detected is the aniline anion (m/z 92), see FIG. 5. Evolution of the aniline anion may be associated with carbonisation of polyaniline base as there is no sulphonic acid and therefore the main decomposition event occurs later peaking around 500° C., see FIG. 6.

### Example 4—X-Ray Photoelectron Spectroscopy (XPS)

XPS may provide information on the elemental composition of samples as well as the particular chemical species present within the 2-dimensional graphitic material.

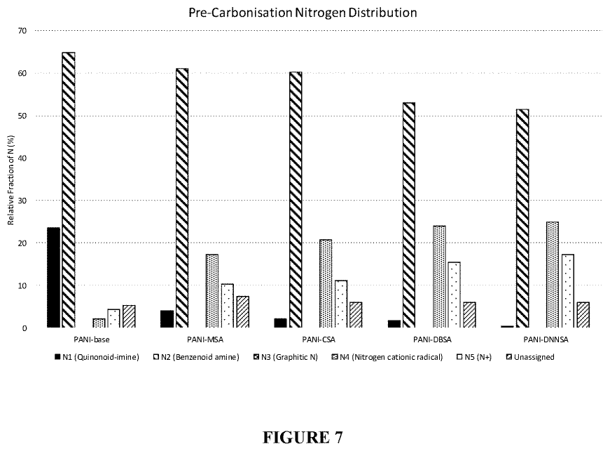

The high resolution N spectrum shows the different N species present in the polyaniline samples (FIG. 7.).

### Example 4a)—XPS Pre-Carbonisation

Pre-carbonisation of the dominant N species present are benzenoid amine (N2), nitrogen cationic radical (N4) and cationic nitrogen (N5).

The polyaniline-DBSA and polyaniline-DNNSA samples show a higher degree of N species associated with the sulphonic acid as would be expected from the S/N data. There is no graphitic nitrogen peak present in the pre-carbonised polyaniline species.

### Example 4b)—XPS Post-Carbonisation

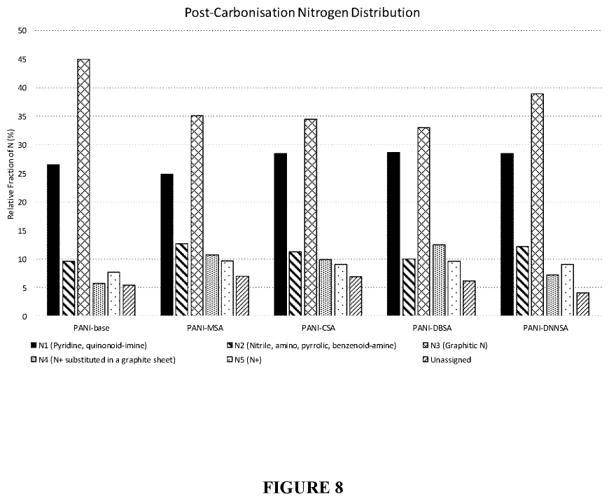

Following carbonisation the type and distribution of nitrogen species present change significantly (FIG. 8).

As shown by FIG. 8, the carbonised polyaniline species (graphitic material) is predominantly composed of graphitic nitrogen (N3), pyridinic nitrogen (N1) and pyrrolic nitrogen (N2).

Polyaniline-base and polyaniline-DNNSA appear to have the highest amount if graphitic nitrogen present in the graphitic material (40% and 45% respectively)

The presence of N4 and N5 may suggest incomplete carbonisation as these peaks are also present in the pre-carbonisation data.

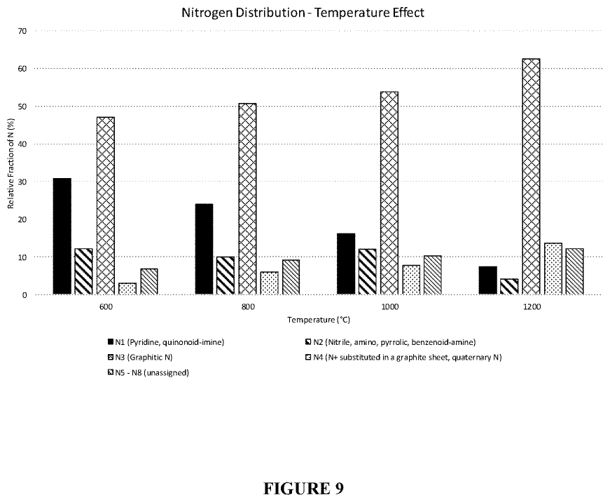

As the pyrolysis temperature is increased the amount of graphitic nitrogen increases (N3) while the amount of pyridinic nitrogen (N1) decreases. This may suggest an increase in crystallinity/order in the graphitic material as the carbonisation temperature is increased (FIG. 9).

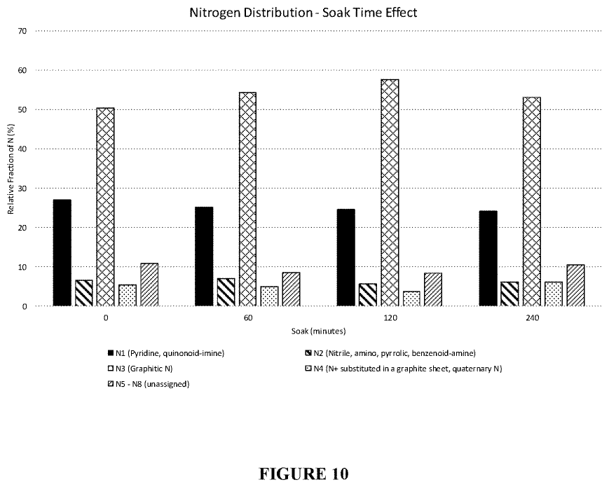

Soak times of 0-4 hours were explored showing very little effect on the nitrogen species present in the resulting graphitic material (FIG. 10). This may indicate that conversion of the conducting polymer to the graphitic material occurs rapidly upon reaching the target carbonisation temperature.

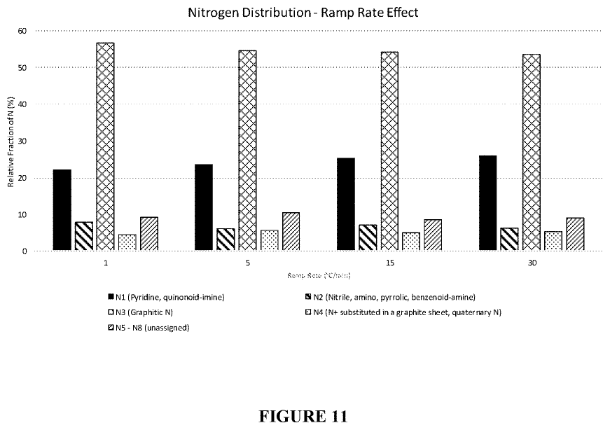

Ramp rates of 1-30° C./min were investigated showing very little effect on the nitrogen species present (FIG. 11). This may further support rapid conversion from the conducting polymer to the graphitic material.

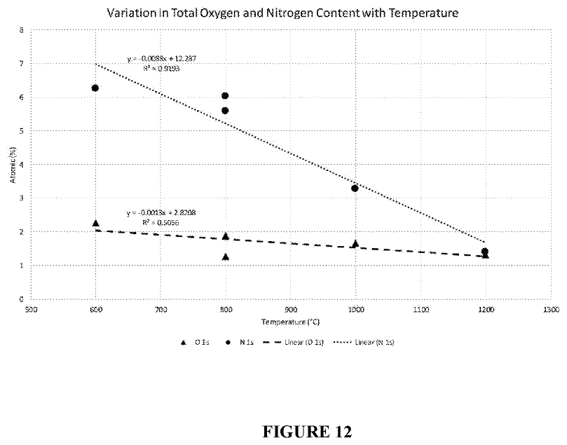

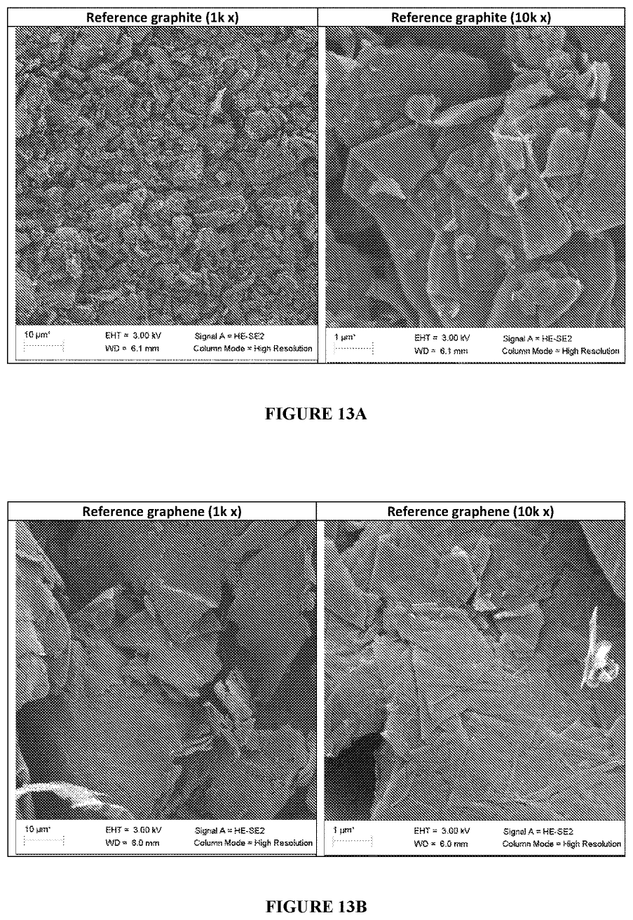

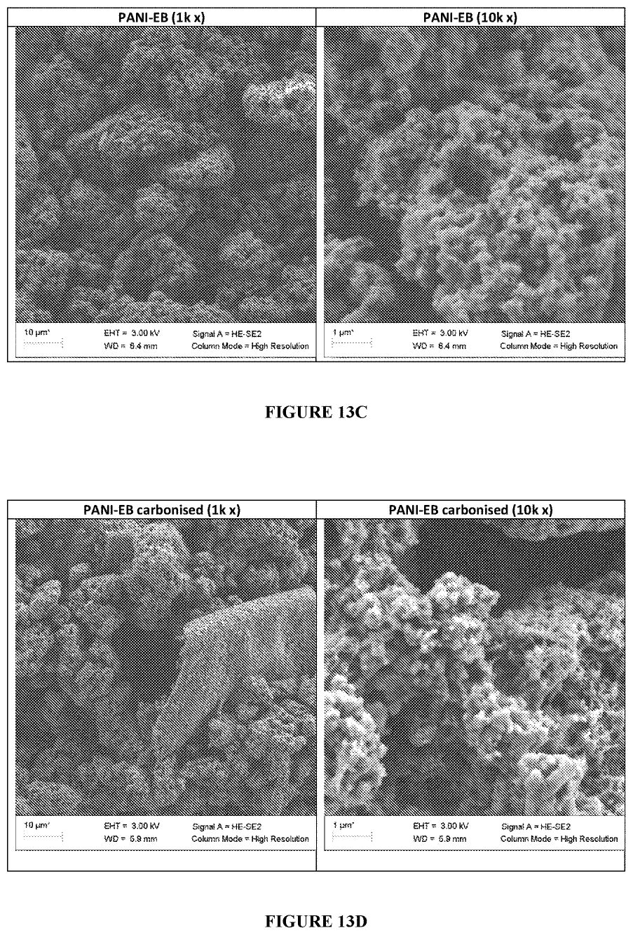

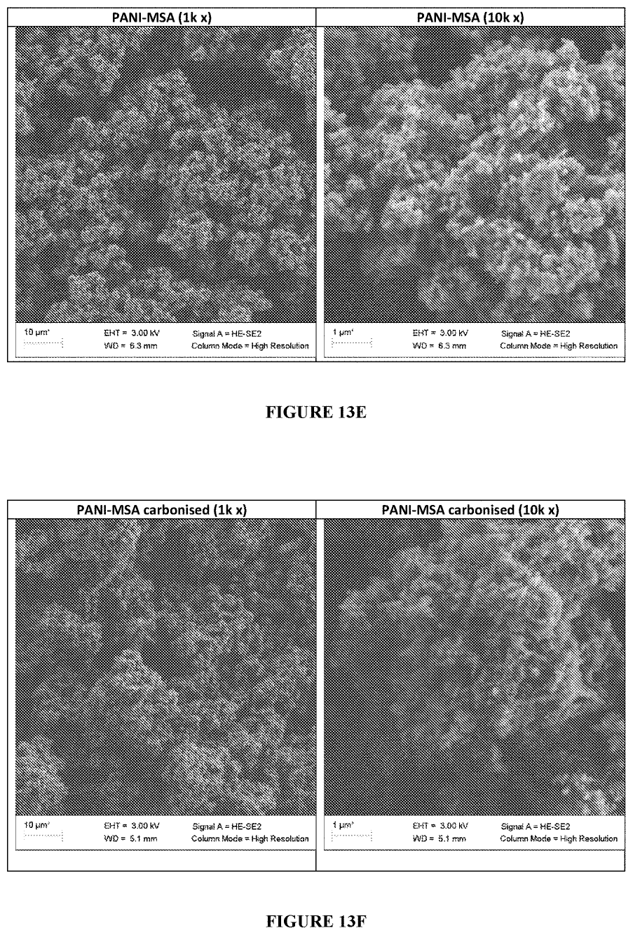

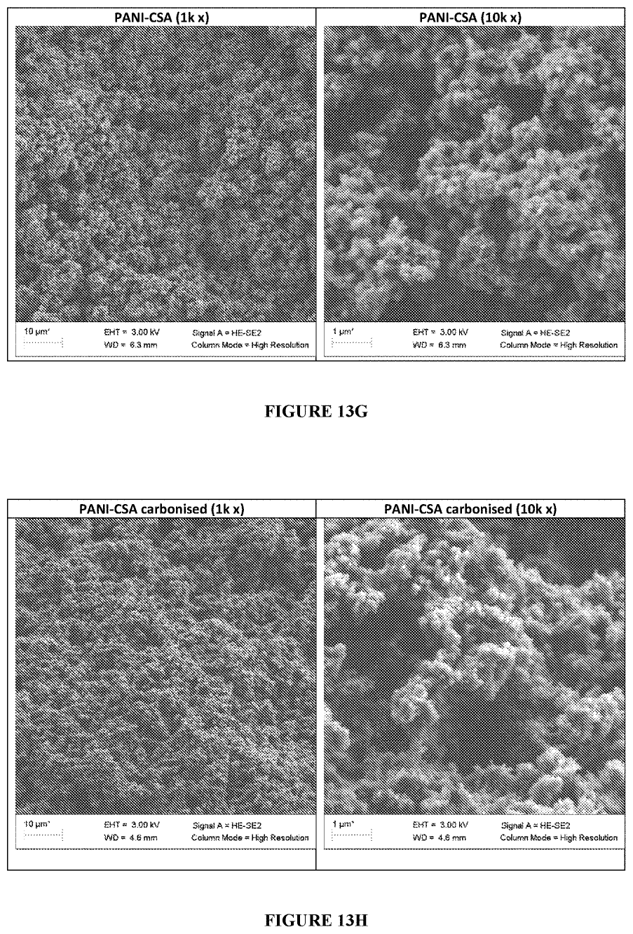

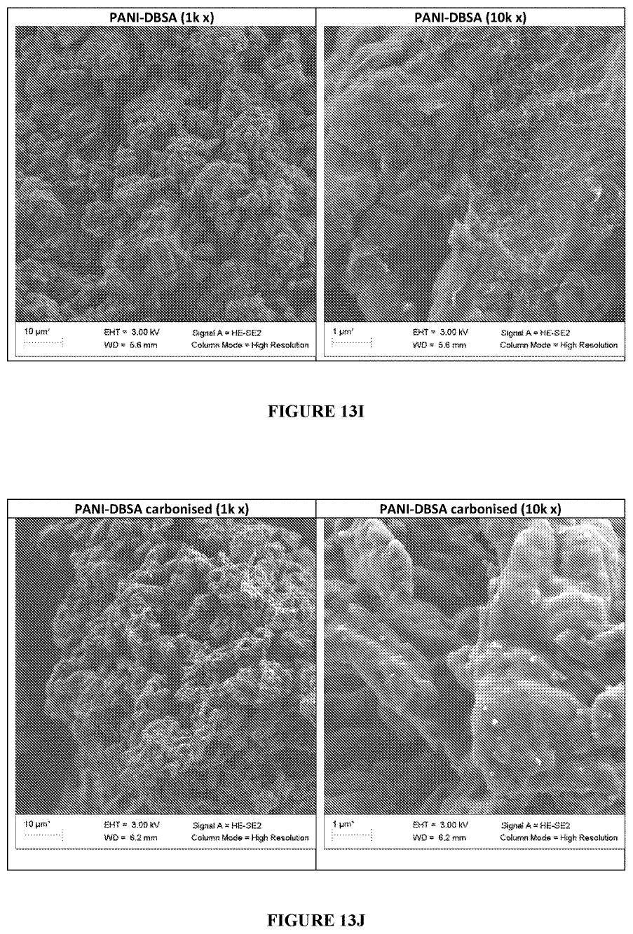

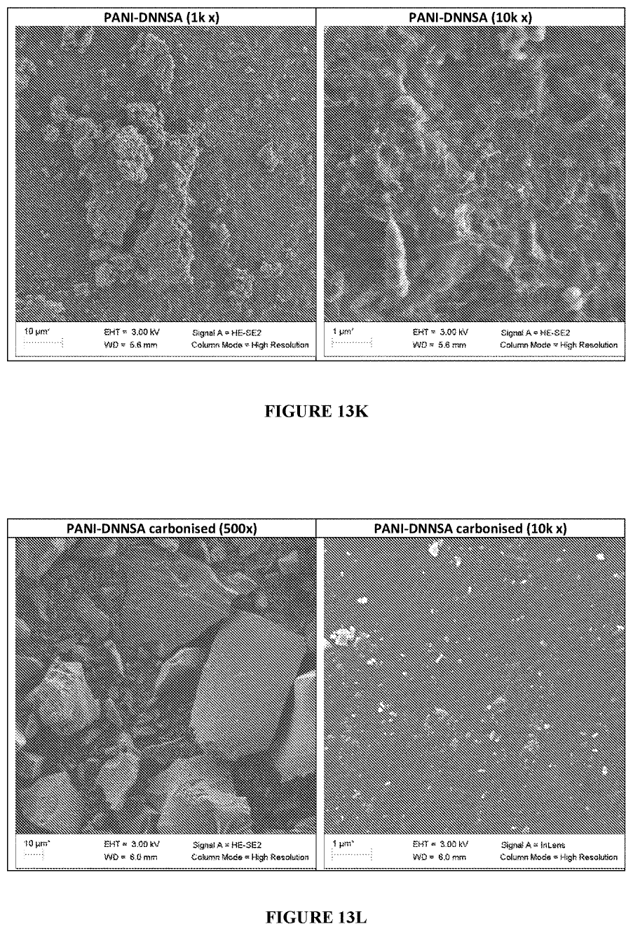

Total atomic (%) of nitrogen and oxygen were shown to decrease linearly as the carbonisation temperature was increased (FIG. 12). All samples were heated at 15° C./min soaking for 1 h at the specified temperature. This may demonstrate the ability to control the heteroatom content of the graphitic material using the carbonisation temperature.

### Example 5—Scanning Electron Microscopy (SEM)

The morphological differences between different polyaniline precursors and their resulting graphitic materials were explored using SEM (FIG. 11). A series of different polyaniline sulphonate salts were synthesised with different sulphonic acids including methane sulfonic acid (MSA), camphorsulfonic acid (CSA), dodocylbenzenesulfonic acid (DBSA) and dinonylnaphthalenesulfonic acid (DNNSA). The resulting powders were then carbonised at 800° C. for 1 h under N_{2(g)} in order to form the graphitic material. A sample of polyaniline emeraldine base (PANI-EB) was also analysed for comparison.

### Example 5a)—Reference Materials

Reference materials of synthetic graphite powder (Sigma Aldrich, 4<20 μm) and graphene nanoplatelets (Knano, KNG-180, ϕ 20-28 μm, t<100 nm) were also evaluated using SEM.

The graphite reference material shows the expected multi-layered structure made up of individual carbon sheets.

The graphene nanoplatelet reference material shows individual carbon sheets or few layer carbon sheets forming larger loosely bound structures but not packed into an orderly 3D layered structure as would be seen in graphite.

### Example 5b)—Polyaniline Base, Polyaniline-MSA, and Polyaniline-CSA

Polyaniline-EB, polyaniline-MSA and polyaniline-CSA all have a fine grain size being made up of clusters of polyaniline nanoparticles. Following carbonisation the morphology of polyaniline-EB, polyaniline-MSA and polyaniline-CSA graphitic materials is retained.

### Example 5c)—Polyaniline-DBSA and Polyaniline-DNNSA

Polyaniline-DBSA and polyaniline-DNNSA have a much larger particle size. These large particles appear to be made up of a fine network of polymer nanofibers. Following carbonisation the morphology changes for polyaniline-DBSA graphitic material with the fibers appearing to ‘weld’ together into larger globular structures. This effect appears enhanced in the case of polyaniline-DNNSA where a greater morphological change occurs providing large, angular particles, in the graphitic material. These show surface patterns indicative of the sheer force required to break the particles. This is also consistent with a semi-crystalline material (e.g. volcanic glass). The surface morphology of these particles is very fine and uniform with local <100 nm crystalline features protruding from the surface.

### Example 6—X-Ray Fluorescence (XRF) Spectroscopy

XRF spectroscopy may be used as a non-destructive method to determine the chemical composition of materials such as loose powders and coatings. It can provide results down to sub-ppm levels for a wide range of elements.

The XRF results in Table 3 for PANI-DNNSA show a sulphur content of 2.10-3.81%. All other trace elements were below the detection limit (Table 3).

After pyrolysis the graphitic material was ground in a tungsten carbide mill in order to give a fine powder suitable for analysis. The sample was then analysed showing greatly reduced sulphur content of 0.07-0.16%.

TABLE 3
Summary of XRF results from the analysis of PANI-DNNSA conducting
polymer powder and the resulting graphitic material.

XRF Results

| | DL | Conducting Polymer | Graphitic Material |
|---|---|---|---|
| Element | (ppm) | (ppm) | (ppm) |
| Cl | 20 | <20 | <20 |
| Br | 10 | <10 | <10 |
| I | 130 | <130 | <130 |
| Na | 40 | <40 | <40 |
| Mg | 20 | <20 | <20 |
| Al | 20 | <20 | 38.1 |
| Si | 20 | <20 | 79.2 |
| P | 10 | <10 | <10 |
| S | 10 | 2.10-3.81% | 0.07-0.16% |
| K | 10 | <10 | <10 |
| Ca | 10 | <10 | 111.0 |
| Sc | 10 | <10 | <10 |
| Ti | 10 | <10 | 33.8 |
| V | 10 | <10 | <10 |
| Cr | 10 | <10 | <10 |
| Mn | 10 | <10 | <10 |
| Fe | 10 | <10 | 47.0 |
| Co | 10 | <10 | 40.2* |
| Ni | 10 | <10 | <10 |
| Cu | 10 | <10 | <10 |
| Zn | 10 | <10 | <10 |
| Ga | 10 | <10 | <10 |
| Ge | 10 | <10 | <10 |
| As | 10 | <10 | <10 |
| Se | 10 | <10 | <10 |
| Mo | 10 | <10 | 34.0 |

*From milling

### Example 7—Raman Spectroscopy

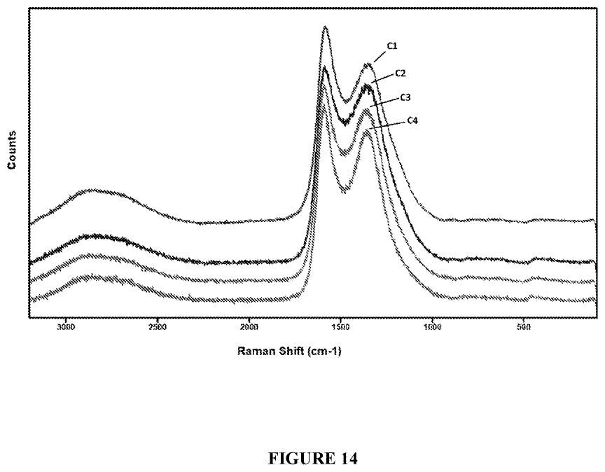

Raman spectra were obtained for graphitic material derived from PANI-DNNSA powder. Samples were carbonised at 600, 800, 1000 and 1200° C. The furnace ramp rate was set to 15° C./min with a 1 h soak in all experiments. Sharpening of the D and G peaks indicates increasing crystallinity as the carbonisation temperature is increased (FIG. 14).

### Example 8—Conductivity of Graphitic Films

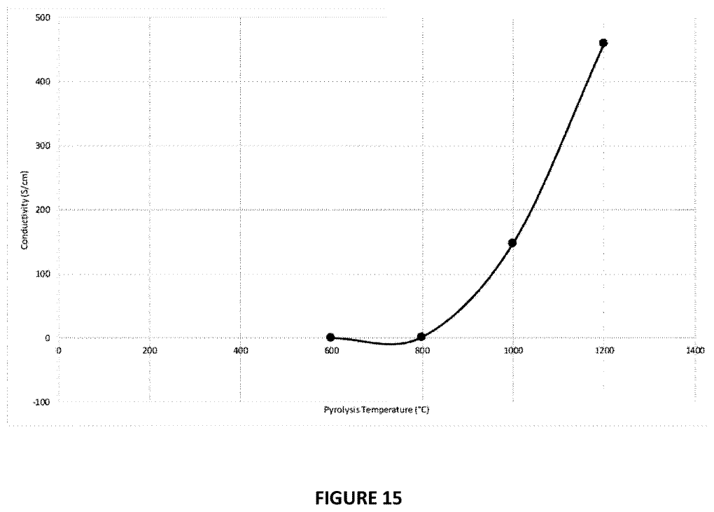

Graphitic films were obtained by pyrolysis of PANI-DNNSA coatings on quartz glass over a range of different temperatures (FIG. 15). The furnace ramp rate was set to 15° C./min with a 1 h soak in all experiments.

The conductivity of the resulting films was measured showing a rapid increase in conductivity with increasing pyrolysis temperature. Conductivities of up to 459 S/cm were achieved at 1200° C. with a film thickness of 332 nm.

1. A method of preparing a graphitic material from a solid conducting polymer material, the method comprising a heating step, and wherein the heating step consists of heating the solid conducting polymer material to a predetermined temperature to provide a solid phase conversion of the solid conducting polymer material into the graphitic material.

2. The method of claim 1, wherein the solid conducting polymer material consists of at least about 70% (by weight) of a solid conducting polymer.

3. The method of claim 1 or 2, wherein the solid conducting polymer material consists of at least about 90% (by weight) of a solid conducting polymer.

4. The method of any one of the preceding claims, wherein the solid conducting polymer material consists of at least about 95% (by weight) of a solid conducting polymer.

5. The method of any one of the preceding claims, wherein the solid conducting polymer material is a bulk powder or coating.

6. The method of any one of the preceding claims, wherein the solid conducting polymer is formed by removal of organic solvent present in a liquid conducting polymer formulation.

7. The method of any one of the preceding claims, wherein the solid conducting polymer material is dissolved in an organic solvent forming a liquid conducting polymer formulation for coating the substrate.

8. The method of claim 7, wherein the solid conductive coating material is formed on a substrate by coating the substrate with the liquid conducting formulation and drying and/or heating the coated substrate to form the solid conductive material coated on the substrate.

9. The method of any one of the preceding claims, wherein the conducting polymer is a homopolymer made from monomeric units of an unsubstituted or substituted monocyclic, bicyclic, or tricyclic heteroaryl monomer and/or an unsubstituted or substituted monocyclic aryl monomer.

10. The method of claim 9, the heteroaryl monomer comprises at least one annular heteroatom selected from nitrogen and sulphur, and the aryl monomer comprises at least one exocyclic heteroatom selected from nitrogen and sulphur.

11. The method of any one of the preceding claims, wherein the conducting polymer is a salt.

12. The method of any one of the preceding claims, wherein the conducting polymer is a phosphorus or sulphur containing salt.

13. The method on any one of the preceding claims, wherein the conducting polymer is a polymerised monocyclic monomer having a single aromatic ring.

14. The method of any one of the preceding claims, wherein the conducting polymer is a sulfonate salt selected from a dinonylnapthalenesulfonate (DNNSA), methanesulfonate (MSA), camphorsulfonate (CSA), p-toluenesufonate (TSA), dodecyl benzene sulfonate (DBSA), dinonylnapthalene sulfonate (DNNSA).

15. The method of any one of the preceding claims, wherein the conducting polymer is a dinonylnapthalene sulfonate salt (DNNSA).

16. The method of any one wherein the ratio of sulphur to nitrogen (S/N ratio) in the solid conducting polymer material is less than about 0.5.

17. The method of any one of the preceding claims, wherein the N content of the graphitic material is a graphitic nitrogen content of between about 1 and 7% (by total weight of the graphitic material).

18. The method of any one of the preceding claims, wherein the S content of the graphitic material is less than about 0.2% (by total weight of the graphitic material).

19. The method of any one of the preceding claims, wherein the 0 content of the graphitic material is between about 1 and 6% (by total weight of the graphitic material).

20. The method of any one of the preceding claims, wherein any trace materials if present in the graphitic materials are present in less than about 50 ppm.

21. The method of claim 20, wherein the trace materials are selected from at least one of a metal, halide and silicon.

22. The method of any one of the preceding claims, wherein the conductivity of the graphitic material is at least about 100 S/cm, preferably at least about 400 S/cm.

23. The method of any one of the preceding claims, wherein the method comprises the following steps:
(i) heating the solid conducting polymer material to a temperature above 550° C. to initiate formation of a graphitic material; and
(ii) cooling the graphitic material.

24. The method of claim 23, wherein the predetermined temperature for step (i) is between about 600° C. to about 1200° C.

25. The method of claim 23, wherein the predetermined temperature for step (i) is between about 800° C. to about 1200° C.

26. The method of any one of the preceding claims, wherein the method is carried out under the flow of an inert gas.

27. The method of any one of the preceding claims, wherein the graphitic material comprises a G band, a 2D band, and optionally a D band.

28. A graphitic material prepared by the method of any one of the preceding claims.

29. A graphitic powder or graphitic filler prepared by the method of any one of the preceding claims.

30. A graphitic coating or graphitic film prepared by the method of any one of claims 1 to 28.

31. A coating on a substrate prepared from the graphitic material prepared according to the method of any one of claims 1 to 28 and 30.

32. A filler comprising the graphitic powder prepared according to the method of any one of claims 1 to 29.

33. A composite comprising the graphitic powder prepared according to the method of claims 1 to 29.

34. A graphitic powder comprising a graphitic material, wherein the graphitic material has a content of heteroatom, and the graphitic powder is prepared by heating a solid conducting polymer material.

35. A graphitic coating on a substrate, wherein the coating comprises a graphitic material, the graphitic material having a content of heteroatom, and wherein the graphitic material is prepared by heating a solid conducting polymer material.
